(19) United States
(12) Patent Application Publication
(10) Pub. No.: US 2026/0288632 A1
(43) Pub. Date: Sep. 24, 2026

(54) MEMORY SYSTEM

(71) Applicant: Kioxia Corporation, Tokyo (JP)

(72) Inventors: Dongxu LI, Kawasaki Kanagawa (JP); Kiyotaro ITAGAKI, Ota Tokyo (JP)

(21) Appl. No.: 19/331,315

(22) Filed: Sep. 17, 2025

(30) Foreign Application Priority Data
Mar. 21, 2025 (JP) 2025-047166

(51) Int. Cl. G06F 12/02

(52) U.S. Cl. CPC G06F 12/0246; G06F 2212/1021

(57) ABSTRACT

A memory system includes: a plurality of semiconductor memory devices and a controller circuit. Each semiconductor memory device includes first, second, third, and fourth pads to which first, second, third, and fourth signals are respectively input, a first input-output circuit configured to receive the second signal in response to toggling of the first signal, a second input-output circuit configured to output user data through the fourth pad in response to toggling of the third signal, a memory cell array storing the user data, a first switch circuit configured to connect the third pad and the first input-output circuit, a decoding circuit configured to control the first switch circuit, and a sequencer including a feature register. The decoding circuit is configured to control the first switch circuit in accordance with a control parameter stored in the feature register and a control signal output from the sequencer during a data out operation.

### CROSS-REFERENCE TO RELATED APPLICATION(S)

This application is based upon and claims the benefit of priority from Japanese Patent Application No. 2025-047166, filed Mar. 21, 2025, the entire contents of which are incorporated herein by reference.

### FIELD

Embodiments described herein relate generally to a memory system.

### BACKGROUND

A memory system including a plurality of semiconductor memory devices and a control device is known. The semiconductor memory device includes a memory cell array including a string where a plurality of memory cell transistors are connected in series.

### BRIEF DESCRIPTION OF THE DRAWINGS

FIG. 1 is a schematic block diagram illustrating a configuration of a memory system according to a first embodiment.

FIG. 2A is a schematic side view illustrating a configuration example of a package, and FIG. 2B is a schematic plan view illustrating the configuration example of the package.

FIG. 3 is a schematic side view illustrating a configuration example of the memory system.

FIG. 4 is a schematic block diagram illustrating a configuration of a memory die.

FIG. 5 is a schematic circuit diagram illustrating a configuration of a part of the memory die.

FIG. 6 is a schematic perspective view illustrating a configuration of a part of the memory die.

FIG. 7 is a schematic circuit diagram illustrating a configuration of a part of the memory die.

FIG. 8 is a schematic circuit diagram illustrating a configuration of a part of the memory die.

FIG. 9 is a schematic diagram illustrating a signal input method from a controller die to the memory die in the first embodiment.

FIG. 10 is a schematic waveform chart illustrating an operation of the memory die.

FIG. 11 is a schematic table illustrating the operation of the memory die.

FIG. 12 is a schematic waveform chart illustrating input/output signals between the controller die and the memory die.

FIG. 13 is a schematic waveform chart illustrating the input/output signals between the controller die and the memory die.

FIG. 14 is a schematic waveform chart illustrating the input/output signals between the controller die and the memory die.

FIG. 15 is a schematic waveform chart illustrating the input/output signals between the controller die and the memory die.

FIG. 16 is a schematic waveform chart illustrating the input/output signals between the controller die and the memory die.

FIG. 17 is a schematic waveform chart illustrating the operation of the memory die.

FIG. 18 is a schematic waveform chart illustrating the operation of the memory die.

FIG. 19 is a schematic waveform chart illustrating the operation of the memory die.

FIG. 20 is a schematic waveform chart illustrating the operation of the memory die.

FIG. 21 is a schematic waveform chart illustrating the operation of the memory die.

FIG. 22 is a schematic waveform chart illustrating the input/output signals between the controller die and the memory die.

FIG. 23 is a schematic waveform chart illustrating the input/output signals between the controller die and the memory die.

FIG. 24 is a schematic waveform chart illustrating the input/output signals between the controller die and the memory die.

FIG. 25 is a schematic waveform chart illustrating the input/output signals between the controller die and the memory die.

FIG. 26 is a table illustrating use of a signal input/output terminal and a control terminal in the memory die.

FIG. 27 is a schematic diagram illustrating functions of a signal input/output terminal and a control terminal in a memory die according to a second embodiment.

FIG. 28 is a schematic waveform chart illustrating input/output signals between the controller die and the memory die.

FIG. 29 is a schematic waveform chart illustrating the input/output signals between the controller die and the memory die.

FIG. 30 is a schematic waveform chart illustrating the input/output signals between the controller die and the memory die.

### DETAILED DESCRIPTION

Embodiments provide a memory system that is operable at a high speed.

In general, according to one embodiment, a memory system includes a plurality of semiconductor memory devices and a controller circuit. Each of the semiconductor memory devices includes a first signal pad to which a first signal is input, a second signal pad to which a second signal is input, a third signal pad to which a third signal is input, a fourth signal pad to which a fourth signal is input, a first input-output circuit configured to receive the second signal as command data or address data in response to toggling of the first signal, a second input-output circuit configured to output user data through the fourth signal pad in response to toggling of the third signal, and a memory cell array including a plurality of memory cell transistors configured to store the user data.

In addition, this memory system includes a first switch circuit configured to connect the third signal pad and the first input-output circuit, a decoding circuit configured to control the first switch circuit, and a sequencer including a feature register. In addition, the decoding circuit is configure to control the first switch circuit in accordance with a first control parameter stored in the feature register and a control signal output from the sequencer when the semiconductor memory device executes a data out operation of outputting the user data through the fourth signal pad.

Hereinafter, a memory system according to an embodiment will be described in detail with reference to the drawings. The following embodiment is merely an example and is not intended to limit the scope of the present disclosure. For convenience of description, some parts of the configuration or the like will not be described. In addition, components common to a plurality of embodiments will be represented by the same reference numerals, and the description thereof will not be repeated in some cases.

In addition, “memory system” described in the present specification may refer to a system, such as a memory card or a solid state drive (SSD), including a memory die and a controller die. Further, “memory system” may also refer to a configuration, such as a smartphone, a tablet terminal, or a personal computer, including a host computer.

In addition, a first configuration being “connected between” a second configuration and a third configuration described in the present specification may refer to a state where the first configuration, the second configuration, and the third configuration are connected in series and the second configuration is connected to the third configuration through the first configuration.

In addition, in the present specification, a predetermined direction parallel to an upper surface of a substrate will be referred to as an X direction, a direction parallel to the upper surface of the substrate and perpendicular to the X direction will be referred to as a Y direction, and a direction perpendicular to the upper surface of the substrate will be referred to as a Z direction.

In addition, regarding a configuration, a member, or the like, “width” or the like in a predetermined direction described in the present specification may refer to “width” or the like in a cross-section or the like observed by scanning electron microscopy (SEM) or transmission electron microscopy (TEM).

### First Embodiment

### Memory System 10

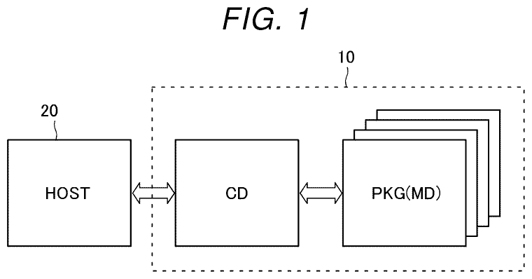

FIG. 1 is a schematic block diagram illustrating a configuration of a memory system 10 according to the present embodiment.

The memory system 10 executes a read operation, a write operation, an erase operation, or the like of user data in accordance with a signal transmitted from a host computer 20. The memory system 10 is, for example, a memory card, an SSD, or other systems that can store the user data. The memory system 10 includes a plurality of packages PKG and a controller die CD connected to the plurality of packages PKG and the host computer 20. Each of the packages PKG includes a plurality of memory dies MD. Each of the memory dies MD can store the user data. The controller die CD includes a controller circuit that includes, for example, a processor and a RAM, and executes a process such as conversion between a logical address and a physical address, bit error detection and correction, garbage collection (also referred to as “compaction”), or wear leveling.

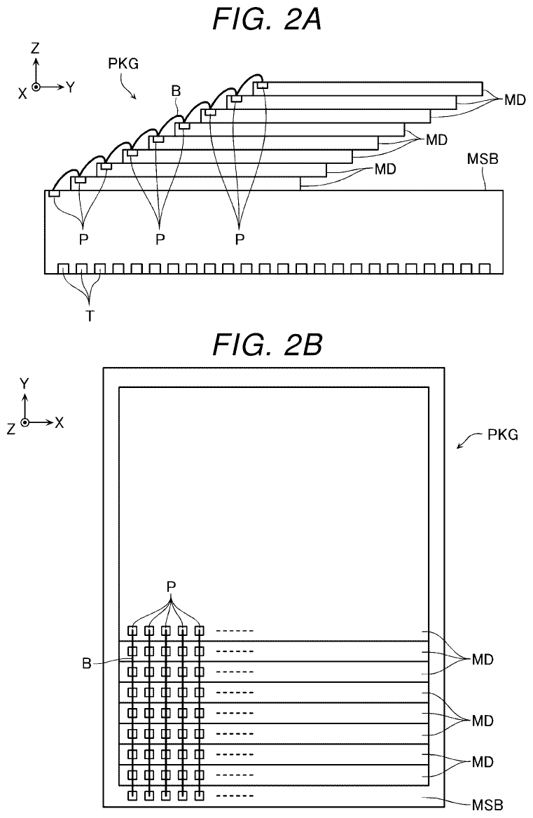

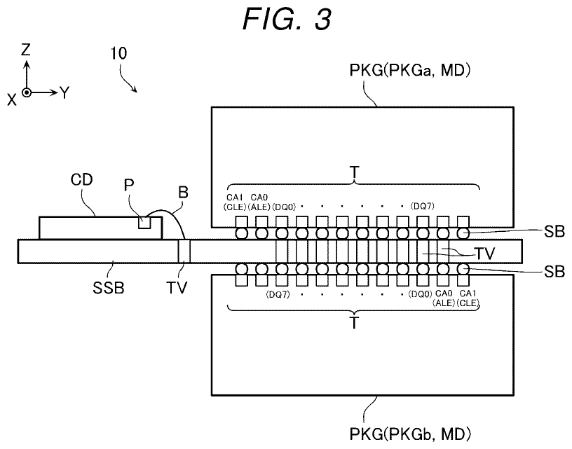

FIGS. 2A and 2B are diagram illustrating a configuration example of the package PKG in the memory system 10 according to the present embodiment. More specifically, FIG. 2A is a schematic side view illustrating the configuration example of the package PKG, and FIG. 2B is a schematic plan view illustrating the configuration example of the package PKG. In addition, FIG. 3 is a schematic side view illustrating a configuration example of the memory system 10. For convenience of description, FIGS. 2A and 2B and 3 do not illustrate some parts of the configuration.

As illustrated in FIG. 2A, the package PKG according to the present embodiment includes a memory die mounting substrate MSB and the plurality of memory dies MD stacked on the memory die mounting substrate MSB. On an upper surface of the memory die mounting substrate MSB, a pad electrode P is provided in a region of an end portion in the Y direction, and a part of the remaining region is bonded to a lower surface of the memory die MD through an adhesive or the like. On an upper surface of the memory die MD, a pad electrode P is provided in a region of an end portion in the Y direction, and the remaining region is bonded to a lower surface of another memory die MD through an adhesive or the like. The corresponding pad electrodes P between the plurality of memory dies MD are connected in common through a bonding wire B. Electrode terminals T are provided on a lower surface of the memory die mounting substrate MSB. The pad electrodes P on the upper surface of the memory die mounting substrate MSB are connected to the electrode terminals T on the lower surface, respectively. The memory die mounting substrate MSB may be, for example, a grid array substrate. On the upper surface of the memory die mounting substrate MSB, the plurality of memory dies MD and the bonding wire B are covered with, for example, a sealing resin (not illustrated).

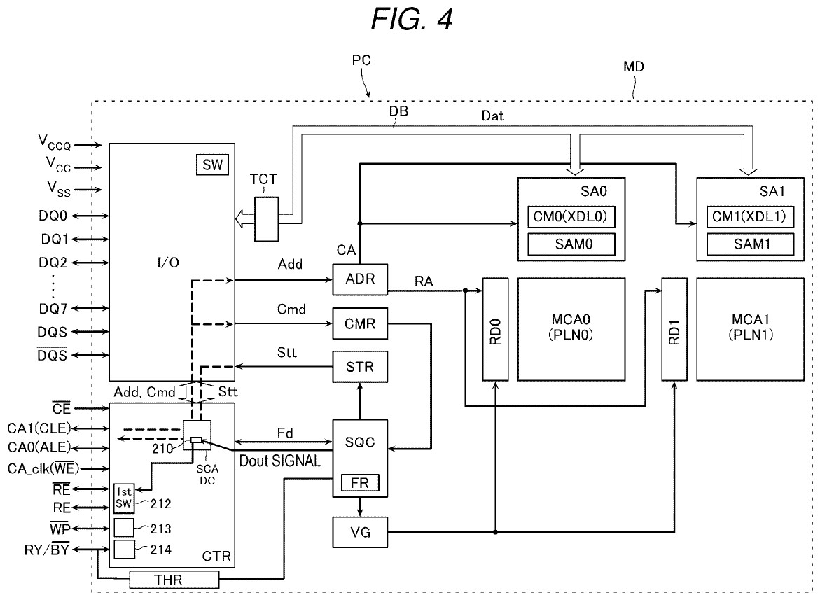

In addition, as illustrated in FIG. 2B, the memory die mounting substrate MSB and each of the plurality of memory dies MD include a plurality of pad electrodes P arranged in the X direction. The plurality of pad electrodes P of each of the memory dies MD correspond to control terminals /CE, CA1(CLE), CA0(ALE), CA_clk(/WE), /RE, RE, and /WP, data signal input/output terminals DQ0 to DQ7, data strobe signal input/output terminals DQS and /DQS, and a terminal RY//BY described below with reference to FIG. 4, respectively.

The memory die mounting substrate MSB and the plurality of pad electrodes P provided in the plurality of memory dies MD are connected to each other through the bonding wire B. For example, in the plurality of memory dies MD, the pad electrodes P corresponding to the control terminal CA1(CLE) are connected to each other, and the pad electrodes P corresponding to the control terminal CA0(ALE) are connected to each other. The same also applies to the other terminals. In addition, the pad electrodes P of each of the memory dies MD in the package PKG are connected to a device outside the package PKG through the electrode terminals T on the lower surface of the memory die mounting substrate MSB.

FIG. 3 is a schematic side view illustrating a configuration example of the memory system 10 according to the present embodiment. The memory system 10 includes a system mounting substrate SSB and the plurality of packages PKG and the controller die CD that are disposed on the system mounting substrate SSB. The controller die CD and some of the packages PKG are disposed on an upper surface of the system mounting substrate SSB. The other packages PKG are disposed on a lower surface of the system mounting substrate SSB.

The plurality of pad electrodes P are provided on the controller die CD. The pad electrodes P of the controller die CD are connected to the system mounting substrate SSB through the bonding wire B. The electrode terminals T of the plurality of packages PKG are connected to the system mounting substrate SSB through solder balls SB. The pad electrodes P of the controller die CD and the electrode terminals T of the plurality of packages PKG are connected through wirings (not illustrated) formed on the upper surface and the lower surface of the system mounting substrate SSB. The upper surface and the lower surface of the system mounting substrate SSB are connected through through-vias TV.

Some of the electrode terminals T of the package PKG disposed on the upper surface of the system mounting substrate SSB and some of the electrode terminals T of the package PKG disposed on the lower surface of the system mounting substrate SSB may be connected through the through-vias TV. More specifically, the electrode terminals T corresponding to the data signal input/output terminals DQ0 to DQ7 in the package PKG disposed on the upper surface of the system mounting substrate SSB may be connected to the electrode terminals T corresponding to the data signal input/output terminals DQ0 to DQ7 in the package PKG disposed on the lower surface of the system mounting substrate SSB, respectively, through the through-vias TV.

When the packages PKG have the same configuration, for example, the electrode terminal T corresponding to the data signal input/output terminal DQ0 in a first package PKG is connected to the electrode terminal T corresponding to the data signal input/output terminal DQ7 in the second package PKG (FIG. 3). Here, the first package PKG will be referred to as a forward connection package PKGa, and the second package PKG will be referred to as a reverse connection package PKGb. The electrode terminal T corresponding to the data signal input/output terminals DQ0, DQ1, DQ2, DQ3, DQ4, DQ5, DQ6, and DQ7 in the forward connection package PKGa are connected to the electrode terminals T corresponding to the data signal input/output terminals DQ7, DQ6, DQ5, DQ4, DQ3, DQ2, DQ1, and DQ0 in the reverse connection package PKGb, respectively. This connection method will be referred to as mirror connection.

The electrode terminals T corresponding to the remaining control terminals are individually connected to the pad electrodes P of the controller die CD. For example, the electrode terminal T corresponding to the control terminal CA1(CLE) in the first package PKG (forward connection package PKGa) and the electrode terminal T corresponding to the control terminal CA1(CLE) in the second package PKG (reverse connection package PKGb) are connected to the pad electrodes P of the controller die CD through different wirings. In addition, the electrode terminal T corresponding to the control terminal CA0(ALE) in the first package PKG (forward connection package PKGa) and the electrode terminal T corresponding to the control terminal CA0(ALE) in the second package PKG (reverse connection package PKGb) are connected to the pad electrodes P of the controller die CD through different wirings.

The configurations illustrated in FIGS. 2A, 2B and 3 are merely an example, and the specific configuration can be appropriately adjusted. For example, in the example illustrated in FIGS. 2A and 2B, the plurality of memory dies MD are stacked, and these configurations are connected through the bonding wire B. However, the plurality of memory dies MD may be connected to each other through through-vias or the like instead of the bonding wire B. In addition, in the example illustrated in FIG. 3, the electrode terminals T (data signal input/output terminals DQ0 to DQ7) of the packages PKG disposed on the upper and lower sides of the system mounting substrate SSB are mirror-connected through the through-vias TV. However, the electrode terminals T (data signal input/output terminals DQ0 to DQ7) of the packages PKG do not need to be mirror-connected. In addition, the controller die CD and one or a plurality of memory dies MD may be provided in the same package.

### Configuration of Memory Die MD

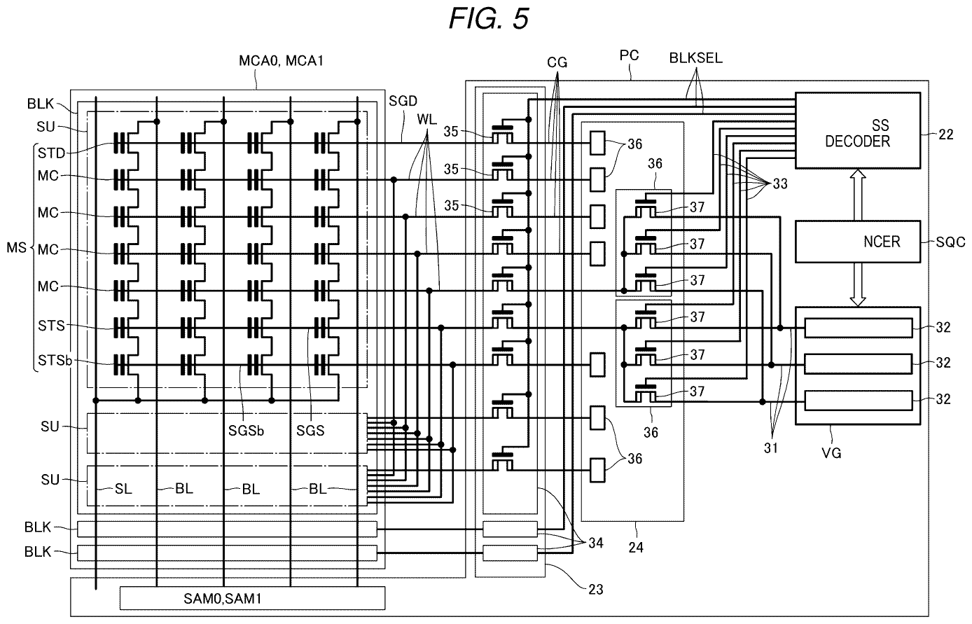

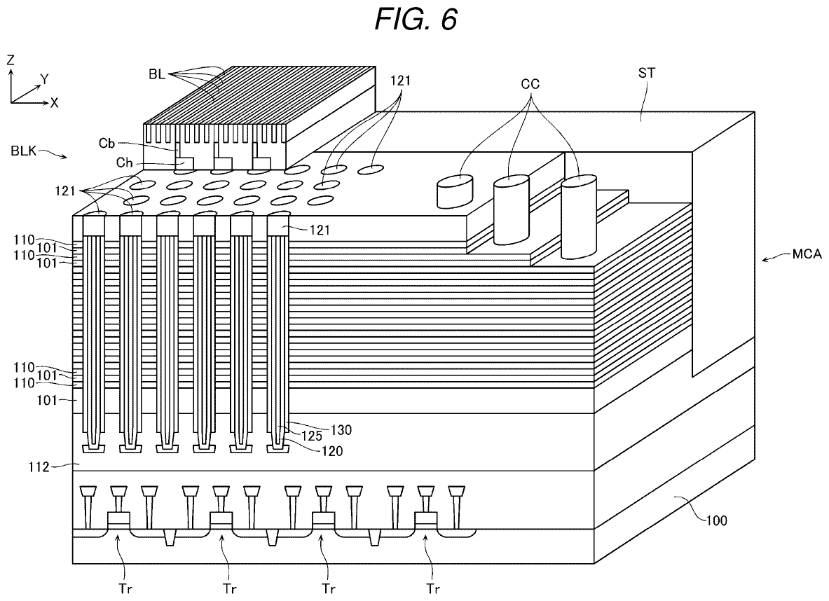

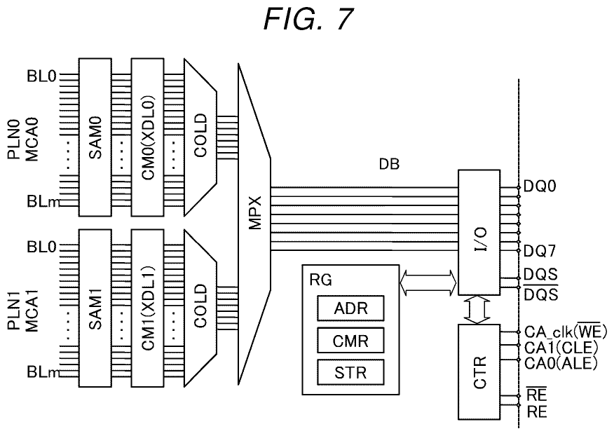

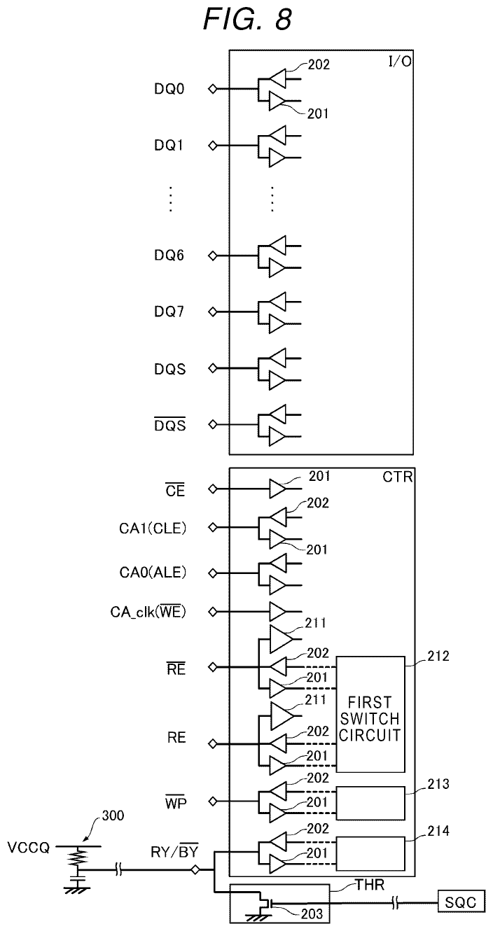

FIG. 4 is a schematic block diagram illustrating a configuration of the memory die MD according to the present embodiment. FIG. 5 is a schematic circuit diagram illustrating a configuration of a part of the memory die MD. FIG. 6 is a schematic perspective view illustrating a configuration of a part of the memory die MD. FIGS. 7 and 8 are schematic circuit diagrams illustrating a configuration of a part of the memory die MD. For convenience of description, FIGS. 4 to 8 do not illustrate some parts of the configuration.

The memory die MD according to the present embodiment is operable in a normal mode and a separate command address protocol (SCA) mode. Hereinafter, the normal mode will also be referred to as a non-SCA mode. More specifically, the memory die MD according to the present embodiment is operable in the normal mode (non-SCA mode), a standard SCA mode (a first mode described below), and at least one different SCA mode (at least one of a second mode, a third mode, a fourth mode, and a fifth mode described below) other than the standard SCA mode. In other words, the SCA modes where the memory die MD according to the present embodiment is operable include the standard SCA mode and at least one different SCA mode.

FIG. 4 illustrates a plurality of control terminals or the like. The plurality of control terminals may be illustrated as a control terminal corresponding to a high active signal (positive logic signal), as a control terminal corresponding to a low active signal (negative logic signal), or as a control terminal corresponding to both of the high active signal and the low active signal. In FIG. 4, a reference numeral of the control terminal corresponding to the low active signal includes an overline. In the present specification, a reference numeral of the control terminal corresponding to the low active signal includes a slash (“/”). The illustration of FIG. 4 is an example, and a specific aspect can be appropriately adjusted. For example, some or all of the high active signals may also be changed to the low active signals, or some or all of the low active signals may also be changed to the high active signals.

In addition, an arrow indicating an input-output direction is illustrated next to each of the plurality of control terminals illustrated in FIG. 4. In FIG. 4, the control terminal with an arrow from the left to the right can be used for inputting data or another signal from the controller die CD to the memory die MD. In FIG. 4, the control terminal with an arrow from the right to the left can be used for outputting data or another signal from the memory die MD to the controller die CD. In FIG. 4, the control terminal with a left-right bidirectional arrow can be used both for inputting data or another signal from the controller die CD to the memory die MD and for outputting data or another signal from the memory die MD to the controller die CD.

As illustrated in FIG. 4, the memory die MD includes: memory cell arrays MCA0 and MCA1 that store the user data; and a peripheral circuit PC that is connected to the memory cell arrays MCA0 and MCA1. In the following description, the memory cell arrays MCA0 and MCA1 will also be referred to as the memory cell array MCA. In addition, the memory cell arrays MCA0 and MCA1 may also be referred to as planes PLN0 and PLN1.

### Configuration of Memory Cell Array MCA

As illustrated in FIG. 5, the memory cell array MCA includes a plurality of memory blocks BLK. Each of the plurality of memory blocks BLK includes a plurality of string units SU. Each of the plurality of string units SU includes a plurality of memory strings MS. Each of first ends of the plurality of memory strings MS is connected to the peripheral circuit PC through a bit line BL. In addition, each of second ends of the plurality of memory strings MS is connected to the peripheral circuit PC through a common source line SL.

The memory strings MS includes a drain-side select transistor STD, a plurality of memory cells MC (also referred to as memory cell transistors), a source-side select transistor STS, and a source-side select transistor STSb that are connected in series between the bit line BL and the source line SL. Hereinafter, the drain-side select transistor STD, the source-side select transistor STS, and the source-side select transistor STSb will also be simply referred to as select transistors (STD, STS, STSb).

The memory cell MC is a field-effect transistor including a semiconductor layer, a gate insulating film, and a gate electrode. The semiconductor layer functions as a channel region. The gate insulating film includes a charge storage film. A threshold voltage of the memory cell MC changes depending on the amount of charge in the charge storage film. The memory cell MC stores user data of one bit or a plurality of bits. A word line WL is connected to each of gate electrodes of the plurality of memory cells MC corresponding to one memory string MS. These word lines WL are connected in common to all of the memory strings MS in one memory block BLK.

The select transistors (STD, STS, STSb) are field-effect transistors including a semiconductor layer, a gate insulating film, and a gate electrode. The semiconductor layer functions as a channel region. Select gate lines (SGD, SGS, SGSb) are connected to gate electrodes of the select transistors (STD, STS, STSb), respectively. The drain-side select gate line SGD is provided corresponding to the string unit SU, and is connected in common to all of memory strings MS in one string unit SU. The source-side select gate line SGS is connected in common to all of the memory strings MS in the memory block BLK. The source-side select gate line SGSb is connected in common to all of the memory strings MS in the memory block BLK.

For example, as illustrated in FIG. 6, the memory cell array MCA is provided over a semiconductor substrate 100. In the example of FIG. 6, a plurality of transistors Tr forming the peripheral circuit PC are provided between the semiconductor substrate 100 and the memory cell array MCA.

The memory cell array MCA includes a plurality of memory blocks BLK arranged in the Y direction. In addition, an inter-block insulating layer ST such as silicon oxide (SiO₂) is provided between two memory blocks BLK adjacent to each other in the Y direction.

For example, as illustrated in FIG. 6, the memory block BLK includes a plurality o conductive layers 110 arranged in the Z direction, a plurality of semiconductor pillars 120 extending in the Z direction, and a plurality of gate insulating films 130 provided between the plurality of conductive layers 110 and the plurality of semiconductor pillars 120, respectively.

The conductive layer 110 is a substantially plate-shaped conductive layer extending in the X direction. The conductive layer 110 may include, for example, a stacked film that includes a barrier conductive film such as titanium nitride (TiN) and a metal film such as tungsten (W). In addition, the conductive layer 110 may include, for example, polycrystalline silicon including impurity such as phosphorus (P) or boron (B). An insulating layer 101 such as silicon oxide (SiO₂) is provided between the plurality of conductive layers 110 arranged in the Z direction.

In addition, among the plurality of conductive layers 110, one or a plurality of conductive layers 110 positioned on the lowermost layer function as the source-side select gate lines SGS and SGSb (FIG. 5) and gate electrodes of the plurality of source-side select transistors STS and STSb connected to the source-side select gate lines SGS and SGSb. The plurality of lowermost conductive layers 110 are electrically independent of each other in each of the memory blocks BLK.

In addition, a plurality of conductive layers 110 positioned over the lowermost conductive layers 110 function as the word lines WL (FIG. 5) and gate electrodes of the plurality of memory cells MC (FIG. 5) connected to the word lines WL. The plurality of conductive layers 110 functioning as the word lines WL are electrically independent of each other in each of the memory blocks BLK.

In addition, one or a plurality of conductive layers 110 positioned over the conductive layers 110 functioning as the word lines WL function as the drain-side select gate line SGD and gate electrodes of a plurality of drain-side select transistors STD (FIG. 5) connected to the drain-side select gate line SGD. The plurality of conductive layers 110 have a smaller width in the Y direction than the other conductive layers 110.

A semiconductor layer 112 is provided below the conductive layers 110. The semiconductor layer 112 may include, for example, polycrystalline silicon including impurity such as phosphorus (P) or boron (B). In addition, the insulating layer 101 such as silicon oxide (SiO₂) is provided between the semiconductor layer 112 and the conductive layer 110.

The semiconductor layer 112 functions as the source line SL (FIG. 5). For example, the source line SL is provided in common for all of the memory blocks BLK in the memory cell array MCA.

For example, as illustrated in FIG. 6, the semiconductor pillars 120 are arranged in a predetermined pattern in the X direction and the Y direction. The semiconductor pillar 120 functions as a channel region of a plurality of memory cells MC and the select transistors (STD, STS, STSb) in one memory string MS (FIG. 5). The semiconductor pillar 120 is, for example, a semiconductor layer such as polycrystalline silicon (Si). For example, as illustrated in FIG. 6, the semiconductor pillar 120 has a substantially bottomed cylindrical shape, in which an insulating layer 125 such as silicon oxide is provided in a center portion. In addition, each of outer peripheral surfaces of the semiconductor pillars 120 is surrounded by the conductive layers 110 at various locations thereof, and faces the conductive layers 110 thereat.

In an upper end portion of the semiconductor pillar 120, an impurity region 121 including N-type impurity such as phosphorus (P) is provided. The impurity region 121 is connected to the bit line BL through a contact Ch and a contact Cb.

The gate insulating film 130 has a substantially bottomed cylindrical shape covering the outer peripheral surface of the semiconductor pillar 120. The gate insulating film 130 includes, for example, a tunnel insulating film, a charge storage film, and a block insulating film stacked between the semiconductor pillar 120 and the conductive layer 110. The tunnel insulating film and the block insulating film are, for example, insulating films such as silicon oxide (SiO₂). The charge storage film is, for example, a film, such as silicon nitride (Si₃N₄) that can store charge. The tunnel insulating film, the charge storage film, and the block insulating film have a substantially cylindrical shape, and extend in the Z direction along the outer peripheral surface of the semiconductor pillar 120 other than a contact portion between the semiconductor pillar 120 and the semiconductor layer 112.

The gate insulating film 130 may include, for example, a floating gate such as polycrystalline silicon including N-type or P-type impurity.

In end portions of the plurality of conductive layers 110 in the X direction, a plurality of contacts CC are provided. The plurality of conductive layers 110 are connected to the peripheral circuit PC through the plurality of contacts CC. As illustrated in FIG. 6, the plurality of contacts CC extend in the Z direction, and are connected to the conductive layers 110 at lower ends thereof. The contact CC may include, for example, a stacked film that includes a barrier conductive film such as titanium nitride (TiN) and a metal film such as tungsten (W).

### Configuration of Peripheral Circuit PC

For example, as illustrated in FIG. 4, the peripheral circuit PC includes row decoders RD0 and RD1 and sense amplifiers SA0 and SA1 connected to the memory cell arrays MCA0 and MCA1, respectively. In addition, the peripheral circuit PC includes a voltage generation circuit VG and a sequencer SQC. In addition, the peripheral circuit PC includes an input/output control circuit I/O, a logic circuit CTR, an address register ADR, a command register CMR, a status register STR, and a data output timing adjusting circuit TCT. In the following description, the row decoders RD0 and RD1 will also be referred to as the row decoder RD, and the sense amplifiers SA0 and SA1 will also be referred to as the sense amplifier SA.

### Configuration of Row Decoder RD

For example, as illustrated in FIG. 5, the row decoder RD (FIG. 4) includes: an address decoder 22 that decodes address data Add (FIG. 4); and a block select circuit 23 and a voltage select circuit 24 that select one of the plurality of memory blocks BLK in accordance with an output signal of the address decoder 22 and transmit an operating voltage to the word line WL in the memory block BLK.

For example, as illustrated in FIG. 5, the address decoder 22 includes a plurality of block select lines BLKSEL and a plurality of voltage select lines 33. For example, the address decoder 22 sequentially refers to row addresses RA of the address register ADR (FIG. 4) in accordance with a control signal from the sequencer SQC, decodes the row addresses RA, sets predetermined block select transistors 35 and predetermined voltage select transistors 37 corresponding to the row addresses RA to an ON state, and sets the remaining block select transistors 35 and the remaining voltage select transistors 37 to an OFF state. For example, voltages of the predetermined block select lines BLKSEL and the predetermined voltage select lines 33 are set to an “H” state, and the remaining voltages are set to a “L” state. When P-channel type transistors are used instead of N-channel type transistors, the opposite voltages are applied to these wirings.

In the example illustrated in the drawing, in the address decoder 22, one block select line BLKSEL is provided for each memory block BLK. However, this configuration can be appropriately changed. For example, one block select lines BLKSEL may be provided for every two or more memory blocks BLK.

For example, as illustrated in FIG. 5, the block select circuit 23 includes a plurality of block select units 34 corresponding to the memory block BLK. Each of the plurality of block select units 34 includes a plurality of block select transistors 35 corresponding to the word line WL and the select gate lines (SGD, SGS, SGSb). The block select transistors 35 are, for example, field-effect breakdown voltage transistors. Each of the drain electrodes of the block select transistors 35 is electrically connected to the corresponding word line WL or the select gate lines (SGD, SGS, SGSb). Each of the source electrodes is electrically connected to a voltage supply line 31 through a wiring CG and the voltage select circuit 24. The gate electrodes are connected in common to the corresponding block select line BLKSEL.

The block select circuit 23 further includes a plurality of transistors (not illustrated). The plurality of transistors are field-effect breakdown voltage transistors connected between the select gate lines (SGD, SGS, SGSb) and a voltage supply line to which a ground voltage V_{SS} is supplied. The plurality of transistors supply the ground voltage V_{SS} to the select gate lines (SGD, SGS, SGSb) in non-selected memory blocks BLK. The plurality of word lines WL in the non-selected memory blocks BLK are in a floating state.

For example, as illustrated in FIG. 5, the voltage select circuit 24 includes a plurality of voltage select units 36 corresponding to the word line WL and the select gate lines (SGD, SGS, SGSb). Each of the plurality of voltage select units 36 includes the plurality of voltage select transistors 37. The voltage select transistors 37 are, for example, field-effect breakdown voltage transistors. Each of drain terminals of the voltage select transistors 37 is electrically connected to the corresponding word line WL or the corresponding select gate lines (SGD, SGS, SGSb) through the wiring CG and the block select circuit 23. Each of source terminals is electrically connected to the corresponding voltage supply line 31. Each of gate electrodes is connected to the corresponding voltage select line 33.

### Configuration of Sense Amplifier SA

The sense amplifiers SA0 and SA1 (FIG. 4) include sense amplifier modules SAM0 and SAM1 and cache memories CM0 and CM1, respectively. The cache memories CM0 and CM1 include latch circuits XDL0 and XDL1, respectively.

In the following description, the sense amplifier modules SAM0 and SAM1 will also be referred to as the sense amplifier module SAM, the cache memories CM0 and CM1 will also be referred to as the cache memory CM, and the latch circuits XDL0 and XDL1 will also be referred to as the latch circuit XDL.

The sense amplifier module SAM includes, for example, a sense circuit corresponding to each of the plurality of bit lines BL and a plurality of latch circuits connected to the sense circuit.

The cache memory CM includes a plurality of latch circuits XDL. Each of the plurality of latch circuits XDL is connected to a latch circuit in the sense amplifier module SAM. The latch circuit XDL stores, for example, user data Dat written in the memory cell MC or user data Dat read from the memory cell MC.

For example, as illustrated in FIG. 7, a column decoder COLD is connected to the cache memory CM. The column decoder COLD decodes a column address CA stored in the address register ADR (FIG. 4), and selects the latch circuit XDL corresponding to the column address CA.

The user data Dat in the plurality of latch circuits XDL are sequentially transmitted to the latch circuit in the sense amplifier module SAM during a write operation. In addition, the user data Dat in the latch circuit in the sense amplifier module SAM is sequentially transmitted to the latch circuit XDL during a read operation. In addition, the user data Dat in the latch circuit XDL is sequentially transmitted to the input/output control circuit I/O through the column decoder COLD and a multiplexer MPX during a data out operation.

### Configuration of Voltage Generation Circuit VG

For example, as illustrated in FIG. 5, the voltage generation circuit VG (FIG. 4) is connected to the plurality of voltage supply lines 31. The voltage generation circuit VG includes, for example, a step-down circuit such as a regulator and a booster circuit such as a charge pump circuit 32. Each of the step-down circuit and the booster circuit is connected to the voltage supply line to which the power supply voltage V_{CC} and a ground voltage V_{SS} (FIG. 4) are supplied. The voltage supply lines are connected to, for example, the pad electrodes P described with reference to FIGS. 2A, 2B and 3. For example, in accordance with a control signal from the sequencer SQC, the voltage generation circuit VG generates a plurality of operating voltages to be applied to the bit line BL, the source line SL, the word line WL, and the select gate lines (SGD, SGS, SGSb) during a read operation, a write operation, and an erase operation on the memory cell array MCA, and simultaneously outputs the generated operating voltages to the plurality of voltage supply lines 31. The operating voltages output from the voltage supply lines 31 are appropriately adjusted in accordance with a control signal from the sequencer SQC.

### Configuration of Sequencer SQC

In accordance with command data Cmd stored in the command register CMR, the sequencer SQC (FIG. 4) outputs internal control signals to the row decoders RD0 and RD1, the sense amplifier modules SAM0 and SAM1, and the voltage generation circuit VG. In addition, the sequencer SQC appropriately outputs status data Stt representing a state of the memory die MD to the status register STR. The state of the memory die MD includes a ready/busy state of the memory die MD.

In addition, the sequencer SQC generates the ready/busy signal, and outputs the generated ready/busy signal to the terminal RY//BY through a circuit THR. The terminal RY//BY is in the “L” state for example, during an operation such as a read operation, a write operation, or an erase operation of supplying a voltage to the memory cell array MCA or during execution of a get feature, a set feature, or the like described below, and is in the “H” state in the other cases. Even when an operation such as a data out operation or a status read of not supplying a voltage to the memory cell array MCA is executed, the terminal RY//BY does not enter the “L” state. In a period (busy period) where the terminal RY//BY is in the “L” state, access to the memory die MD is basically prohibited. In addition, in a period (ready period) where the terminal RY//BY is in the “H” state, access to the memory die MD is permitted. The terminal RY//BY is implemented by, for example, the pad electrode P described with reference to FIGS. 2A, 2B and 3.

When the memory die MD executes the data out operation, the sequencer SQC outputs a Dout signal to a SCA decoder described below in the logic circuit CTR.

In addition, the sequencer SQC includes a feature register FR. The feature register FR is a register that stores feature data Fd. The feature data Fd includes, for example, a control parameter of the memory die MD.

### Configuration of Address Register ADR

As illustrated in FIG. 4, the address register ADR is connected to the input/output control circuit I/O, and stores address data Add input from the input/output control circuit I/O. The address register ADR includes, for example, a plurality of 8-bit register arrays. For example, when an internal operation such as a read operation, a write operation, or an erase operation is executed, the register array stores the address data Add corresponding to the internal operation that is being executed.

The address data Add includes, for example, a column address CA (FIG. 4) and a row address RA (FIG. 4). The row address RA includes, for example, a block address that specifies the memory block BLK (FIG. 5), a page address that specifies the string unit SU and the word line WL, a plane address that specifies the memory cell array MCA (plane), and a chip address that specifies the memory die MD.

### Configuration of Command Register CMR

The command register CMR (FIG. 4) is connected to the input/output control circuit I/O, and stores the command data Cmd input from the input/output control circuit I/O. The command register CMR includes, for example, at least one 8-bit register array. When the command register CMR stores the command data Cmd, a control signal is transmitted to the sequencer SQC.

### Configuration of Status Register STR

The status register STR (FIG. 4) is connected to the input/output control circuit I/O, and stores the status data Stt to be output to the input/output control circuit I/O. The status register STR includes, for example, a plurality of 8-bit register arrays. For example, when an internal operation such as a read operation, a write operation, or an erase operation is executed, the register array stores the status data Stt regarding the internal operation that is being executed. In addition, the register array stores, for example, ready/busy information representing ready/busy states of the memory cell arrays MCA0 and MCA1.

### Configuration of Data Output Timing Adjusting Circuit TCT

The data output timing adjusting circuit TCT (FIG. 4) is connected to a bus wiring DB between the cache memories CM0 and CM1 and the input/output control circuit I/O. For example, when the data out operation is continuously executed on the cache memories CM0 and CM1, the data output timing adjusting circuit TCT adjusts a start timing of the data out operation on the cache memory CM1 to start the data out operation of the cache memory CM1 without a time interval after completion of the data out operation on the cache memory CM0.

### Configuration of Input/output Control Circuit I/O

The input/output control circuit I/O (FIG. 4) includes the data signal input/output terminals DQ0 to DQ7, the data strobe signal input/output terminals DQS and /DQS, a shift register, a buffer circuit, and a connection change circuit SW.

Each of the data signal input/output terminals DQ0 to DQ7 and the data strobe signal input/output terminals DQS and /DQS is implemented by, for example, the pad electrode P described with reference to FIGS. 2A, 2B and 3. Data input through the data signal input/output terminals DQ0 to DQ7 is input from the buffer circuit to the cache memory CM in accordance with the internal control signal from the logic circuit CTR. In addition, data output through the data signal input/output terminals DQ0 to DQ7 is input from the cache memory CM or the status register STR to the buffer circuit in accordance with the internal control signal from the logic circuit CTR.

A signal (for example, a data strobe signal or a complementary signal thereof) input through the data strobe signal input/output terminals DQS and /DQS is used for inputting data through the data signal input/output terminals DQ0 to DQ7. The data input through the data signal input/output terminals DQ0 to DQ7 is taken into the shift register in the input/output control circuit I/O at timings of a rising edge of a voltage of the data strobe signal input/output terminal DQS and a falling edge of a voltage of the data strobe signal input/output terminal /DQS and at timings of a falling edge of a voltage of the data strobe signal input/output terminal DQS and a rising edge of a voltage of the data strobe signal input/output terminal /DQS.

Each of the data signal input/output terminals DQ0 to DQ7 and the data strobe signal input/output terminals DQS and /DQS is connected to an input circuit 201 and an output circuit 202, for example, as illustrated in FIG. 8. The input circuit 201 is, for example, a receiver such as a comparator. The output circuit 202 is, for example, a driver such as an off chip driver (OCD) circuit.

The connection change circuit SW (FIG. 4) is a circuit that changes the order of data input from the outside of the memory die MD to the data signal input/output terminals DQ0 to DQ7 when the data is input into the memory die MD.

The connection change circuit SW (FIG. 4) determines whether each of the memory dies MD is provided in the forward connection package PKGa or the reverse connection package PKGb, for example, based on the feature data Fd stored in the feature register FR. In addition, when the connection change circuit SW determines that the memory die MD is provided in the reverse connection package PKGb, the connection change circuit SW (FIG. 4) changes the order of data input to the data signal input/output terminals DQ0 to DQ7.

### Configuration of Logic Circuit CTR

The logic circuit CTR (FIG. 4) includes the plurality of control terminals /CE, CA1(CLE), CA0(ALE), CA_clk(/WE), /RE, RE, and /WP, and a logic circuit CTR, that includes a SCA decoder, a first switch circuit 212, a second switch circuit 213, and a third switch circuit 214, and are connected to the plurality of control terminals /CE, CA1(CLE), CA0(ALE), CA_clk(/WE), /RE, RE, and /WP. The logic circuit CTR receives an external control signal from the controller die CD through the control terminals /CE, CA1(CLE), CA0(ALE), CA_clk(/WE), /RE, RE, and /WP, and outputs the internal control signal to the input/output control circuit I/O in accordance with the external control signal. In addition, depending on settings, the logic circuit CTR can receive the external control signal from the controller die CD through the control terminals /RE, RE, and /WP or through the terminal RY//BY, and can output the internal control signal to the input/output control circuit I/O in accordance with the external control signal.

Each of the control terminals /CE, CA1(CLE), CA0(ALE), CA_clk(/WE), /RE, RE, and /WP and the terminal RY//BY is connected to the input circuit 201, for example, as illustrated in FIG. 8. In addition, each of the control terminals CA0(ALE), CA1(CLE), /RE, RE, and /WP and the terminal RY//BY is also connected to the output circuit 202 in addition to the input circuit 201. Each of the control terminals /RE and RE is also connected to an input circuit 211. The input circuit 201 and the output circuit 202 connected to the control terminals /RE and RE are connected to the first switch circuit 212. The input circuit 201 and the output circuit 202 connected to the control terminal /WP are connected to the second switch circuit 213. The input circuit 201 and the output circuit 202 connected to the terminal RY//BY are connected to the third switch circuit 214.

Each of the control terminals /CE, CA1(CLE), CA0(ALE), CA_clk(/WE), /RE, RE, and /WP is implemented by, for example, the pad electrode P described with reference to FIGS. 2A, 2B and 3.

A signal (for example, a chip enable signal) input through the control terminal /CE is used for selecting the memory die MD. The memory die MD where “L” is input to the control terminal /CE is in a state where the user data Dat, the command data Cmd, the address data Add, and the status data Stt (hereinafter, also simply referred to as “data”) can be input and output. The memory die MD where “H” is input to the control terminal /CE is in a state where the data cannot be input and output. As illustrated in FIG. 8, the control terminal /CE is connected to the input circuit 201.

A signal (for example, a command latch enable signal) input through the control terminal CA1(CLE) is used, for example, for using the command register CMR. In addition, the signal input through the control terminal CA1(CLE) is used, for example, for using the command register CMR, and is also used as the command data Cmd and the address data Add. Further, the status data Stt is output from the status register STR through the control terminal CA1(CLE), the feature data Fd is input to the feature register FR through the control terminal CA1(CLE), and the feature data Fd is output from the feature register FR through the control terminal CA1(CLE). In the present embodiment, when the memory die MD operates in the separate command address protocol (SCA) mode, a signal including two or more sets of data input in a time-division manner is input from the controller die CD to the memory die MD through the control terminal CA0(ALE) and the control terminal CA1(CLE). The two or more sets of data input in a time-division manner are acquired from signals input through the control terminal CA0(ALE) and the control terminal CA1(CLE) at timings of a rising edge of a voltage of the control terminal CA_clk(/WE) described below (for example, switching from the “L” state to the “H” state) and a falling edge of a voltage of the control terminal CA_clk(/WE) (for example, switching from the “H” state to the “L” state). The function of the control terminal CA1(CLE) will be described below.

A signal (for example, an address latch enable signal) input through the control terminal CA0(ALE) is used, for example, for using the address register ADR. In addition, the signal input through the control terminal CA0(ALE) is used, for example, for using the address register ADR, and is also used as the command data Cmd and the address data Add. Further, the status data Stt is output from the status register STR through the control terminal CA0(ALE), the feature data Fd is input to the feature register FR through the control terminal CA0(ALE), and the feature data Fd is output from the feature register FR through the control terminal CA0(ALE). The function and the like of the control terminal CA0(ALE) will be described below.

A signal (for example, a write enable signal) input through the control terminal CA_clk(/WE) is used, for example, for inputting data from the controller die CD to the memory die MD. The function and the like of the control terminal CA_clk(/WE) will be described below.

A signal (for example, a read enable signal or a complementary signal thereof) input through the control terminals /RE and RE is used for outputting data through the data signal input/output terminals DQ0 to DQ7. The data output from the data signal input/output terminals DQ0 to DQ7 is switched at timings of a falling edge of a voltage of the control terminal /RE and a rising edge of a voltage of the control terminal RE and at a timing of a rising edge of a voltage of the control terminal /RE and a falling edge of a voltage of the control terminal RE.

It should be noted that, in the present embodiment, the functions of the control terminals /RE and RE are switchable depending on settings. For example, the signal input through the control terminals /RE and RE may also be used as the command data Cmd and the address data Add. Further, the status data Stt may be output from the status register STR through the control terminals /RE and RE, the feature data Fd may be input to the feature register FR through the control terminals /RE and RE, and the feature data Fd may be output from the feature register FR through the control terminals /RE and RE.

A signal (for example, a write-protect signal) input through the control terminal /WP is used, for example, for restricting input of the user data Dat from the controller die CD to the memory die MD.

It should be noted that, in the present embodiment, the functions of the control terminal /WP are switchable depending on settings. For example, the signal input through the control terminal /WP may also be used as the command data Cmd and the address data Add, the status data Stt may be output from the status register STR through the control terminal /WP, the feature data Fd may be input to the feature register FR through the control terminal /WP, and the feature data Fd may be output from the feature register FR through the control terminal /WP.

A voltage supply circuit 300 provided outside the memory die MD is connected to the terminal RY//BY. The voltage supply circuit 300 includes a resistor element and a capacitor that are connected in series. A power supply voltage V_{CCQ} is supplied from the outside of the memory die MD to the terminal RY//BY through the resistor element of the voltage supply circuit 300. In addition, the terminal RY//BY is connected to a grounding terminal provided outside the memory die MD through the capacitor of the voltage supply circuit 300.

In addition, the terminal RY//BY is connected to the circuit THR. The circuit THR includes, for example, a sinker transistor 203. The sinker transistor 203 is, for example, a field-effect NMOS transistor. In the sinker transistor 203, a drain electrode is connected to the terminal RY//BY, a gate electrode is connected to the sequencer SQC, and a source electrode is grounded.

It should be noted that, in the present embodiment, the functions of the terminal RY//BY are switchable depending on settings. For example, the signal input through the terminal RY//BY may also be used as the command data Cmd and the address data Add, the status data Stt may be output from the status register STR through the terminal RY//BY, the feature data Fd may be input to the feature register FR through the terminal RY//BY, and the feature data Fd may be output from the feature register FR through the terminal RY//BY. In this case, the terminal RY//BY and the voltage supply circuit 300 are electrically separated from each other. The terminal RY//BY and the voltage supply circuit 300 may be electrically separated from each other through a switch (not illustrated). In addition, by not providing the voltage supply circuit 300, or by not providing the bonding wire through which the voltage supply circuit 300 and the terminal RY//BY are connected, the terminal RY//BY and the voltage supply circuit 300 may be electrically separated from each other.

The first switch circuit 212 connects the control terminals /RE and RE and the SCA decoder with each other. More specifically, as illustrated in FIG. 8, the first switch circuit 212 connects the input circuit 201 and the output circuit 202 that are connected to the control terminals /RE and RE. The first switch circuit 212 is switched on depending on settings, and connects the input circuit 201 or the output circuit 202 and the SCA decoder with each other in accordance with a signal input to or output from the control terminals /RE and RE. The first switch circuit 212 is switched off when the memory die MD executes the data out operation.

The second switch circuit 213 connects the control terminal /WP and the SCA decoder with each other. More specifically, as illustrated in FIG. 8, the second switch circuit 213 connects with the input circuit 201 and the output circuit 202 that are connected to the control terminal /WP. The second switch circuit 213 is switched on depending on settings, and connects the input circuit 201 or the output circuit 202 and the SCA decoder with each other in accordance with a signal input to or output from the control terminal /WP.

The third switch circuit 214 connects the terminal RY//BY and the SCA decoder with each other. More specifically, as illustrated in FIG. 8, the third switch circuit 214 connects with the input circuit 201 and the output circuit 202 that are connected to the terminal RY//BY. The third switch circuit 214 is switched on depending on settings, and connects the input circuit 201 or the output circuit 202 and the SCA decoder with each other in accordance with a signal input to or output from the terminal RY//BY.

In alterative embodiments, the first switch circuit 212 may be connected between the control terminals /RE and RE and the input circuit 201 and the output circuit 202. With this configuration, during the data out operation, the control terminals /RE and RE can be electrically separated from the input circuit 201 and the output circuit 202 to reduce the capacitance such that a signal can be input to the input circuit 211 at a higher speed. The second switch circuit 213 may be connected between the control terminal /WP and the input circuit 201 and the output circuit 202. Likewise, the third switch circuit 214 may also be connected between the terminal RY//BY and the input circuit 201 and the output circuit 202.

In addition, the logic circuit CTR may further include a switch circuit connected between the control terminals /RE and RE and the input circuit 211 and a switch circuit connected between the terminal RY//BY and the circuit THR.

The SCA decoder (FIG. 4) controls on/off of the first switch circuit 212 in accordance with the feature data Fd in the feature register FR and the Dout signal. That is, the feature data Fd includes flag data that enables data to be input and output through the control terminals /RE and RE. When the flag data is in a first state and the Dout signal is in the “L” state (when the data out operation is not executed), the SCA decoder switches on the first switch circuit 212 to enter a state where data can be input and output through the control terminals /RE and RE. For example, even in a state where the first switch circuit 212 is allowed to be switched on in accordance with the flag data stored in the feature register FR, when the Dout signal in the “H” state is output from the sequencer SQC, the SCA decoder switches off the first switch circuit 212.

In addition, the SCA decoder controls on/off of the second switch circuit 213 and the third switch circuit 214 in accordance with the feature data Fd in the feature register FR. That is, the feature data Fd includes flag data that enables data to be input and output through the control terminal /WP and flag data that enables data to be input and output through the terminal RY//BY. When these flag data are in the first state, the SCA decoder switches on the second switch circuit 213 and the third switch circuit 214 to enter a state where data can be input and output through the control terminal /WP and the terminal RY//BY.

In addition, although not illustrated in the drawings, the logic circuit CTR includes an n-bit register array (n represents an integer of 2 or more) and an 8-bit register array. The n-bit register stores a header set described below including n bits (in the present embodiment, 4 bits). The 8-bit register stores a body set described below including 8 bits. The logic circuit CTR receives data of 2 bits input through the control terminals CA1(CLE) and CA0(ALE), for example, at a timing of switching of the signal input to the control terminal CA_clk(/WE). In addition, when data can be input and output through at least one of the control terminals /RE, RE, and /WP and the terminal RY//BY, the logic circuit CTR further receives data of 1 to 4 bits input through the terminals at a timing of switching of the signal input to the control terminal CA_clk(/WE). In addition, the logic circuit CTR sequentially stores the received data of 2 to 6 bits in the n-bit register array and the 8-bit register array. In addition, the logic circuit CTR transmits the body set stored in the 8-bit register array to the address register ADR, the command register CMR, the feature register FR, and the like in accordance with the header set stored in the n-bit register array.

### Signal Input Method From Controller Die CD to Memory Die MD

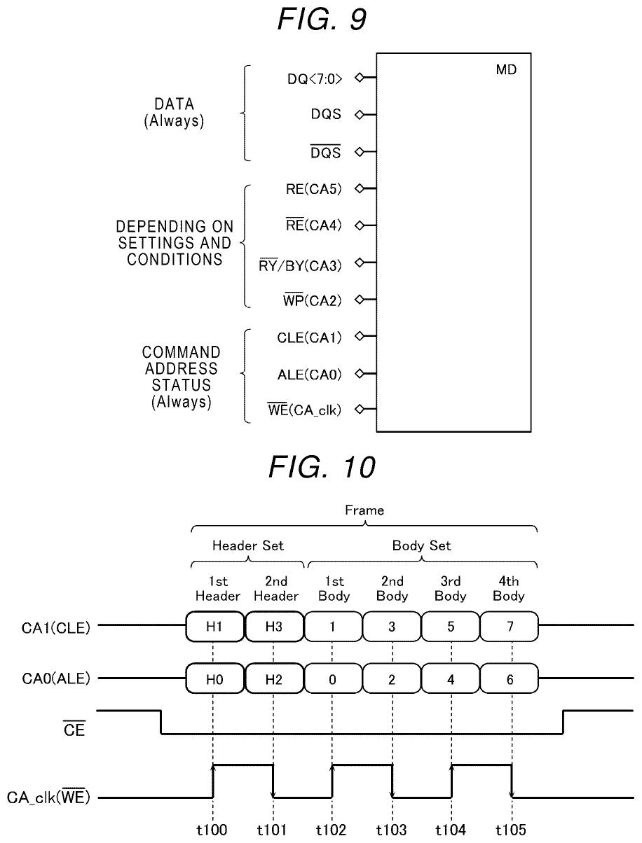

Next, a signal input method from the controller die CD to the memory die MD according to the present embodiment will be described with reference to FIGS. 9 to 25.

### Function of Each of Terminals

FIG. 9 is a schematic diagram illustrating the functions of the signal input/output terminal and the control terminal in the memory die MD. In the following description, the data signal input/output terminals DQ0 to DQ7 will be referred to as the data signal input/output terminals DQ<7:0> in some cases.

For example, in the memory die MD according to the present embodiment illustrated in FIG. 9, the data signal input/output terminals DQ<7:0> are typically used for inputting and outputting the user data Dat, and are not used for inputting the command data Cmd and the address data Add and for outputting the status data Stt. In addition, in the memory die MD according to the present embodiment, the control terminals CA0(ALE) and CA1(CLE) are used for inputting the command data Cmd and the address data Add and for outputting the status data Stt or the like, and the control terminal /WE is used for inputting a clock signal transmitted from the controller die CD during the input and output of these data. In addition, in the memory die MD according to the present embodiment, depending on settings, the control terminals /RE and RE, the control terminal /WP, and the terminal RY//BY can be used for inputting the command data Cmd and the address data Add and for outputting data such as the status data Stt.

Some of the signals input and output through the control terminals CA0(ALE) and CA1(CLE) of the memory die MD according to the present embodiment may also be referred to as a header. In addition, a combination of the headers forming the signals may also be referred to as a header set. In the present embodiment, the header set includes a signal of 4 bits.

In addition, some of the command data Cmd, the address data Add, the status data Stt, the feature data Fd, and the like input and output following the header may also be referred to as a body. In addition, a combination of the bodies forming the data or a part thereof may also be referred to as a body set. In the present embodiment, the body set includes data of 8 bits.

In addition, a combination of one header set and one body set may also be referred to as a frame.

In the following description, a mode in which only the control terminals CA0(ALE) and CA1(CLE) are used for inputting the command data Cmd and the address data Add, for outputting the status data Stt, and for inputting and outputting the feature data Fd will be referred to as a first mode (standard SCA mode). It can be said that the first mode is a mode in which the two terminals are used, for example, for inputting the command data Cmd and the address data Add.

In the first mode, the data of 2 bits input through the control terminals CA0(ALE) and CA1(CLE) is taken into a register (not illustrated) of the logic circuit CTR at timings of a rising edge and a falling edge of a voltage of the control terminal CA_clk(/WE). That is, the data of the control terminals CA0(ALE) and CA1(CLE) is taken into a register (not illustrated) of the logic circuit CTR in response to toggling of the signal input to the control terminal CA_clk(/WE). In the present specification, when a voltage level of the control terminal CA_clk(/WE) is toggled once (at a timing of a rising edge or a falling edge of a voltage of the control terminal CA_clk(/WE)), input of data through the control terminals CA0(ALE) and CA1(CLE) or the like is set as one cycle. For example, in the first mode (standard SCA mode), when a voltage level of a clock signal input to the control terminal CA_clk(/WE) is toggled once (at a timing of a rising edge or a falling edge of the clock signal input to the control terminal CA_clk(/WE)), input of data of 2 bits through the control terminals CA0(ALE) and the CA1(CLE) is set as one cycle.

### Example of Data Input in First Mode

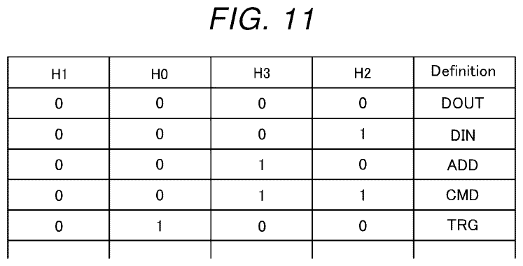

FIG. 10 is a schematic waveform chart illustrating the operation of the memory die MD according to the present embodiment. FIG. 11 is a schematic waveform chart illustrating the operation of the memory die MD.

FIG. 10 illustrates a waveform when the header set is input during the operation of the memory die MD in the first mode. In the example of FIG. 10, in a state where the signal of the “L” state is input to the control terminal /CE, the signal of the “L” state and the signal of the “H” state are input to the control terminal CA_clk(/WE) at a substantially fixed cycle. That is, in a state where the input signal of the control terminal /CE is in the “L” state, the input signal of the control terminal CA_clk(/WE) repeats switching (two times of toggling) where the input signal rises from “L” to “H” once and falls from “H” to “L”.

In the example of FIG. 10, at timing t100 and timing t101, the header set of 4 bits corresponding to the rising edge and the falling edge of the signal input to the control terminal CA_clk(/WE) is input. More specifically, at timing t100 and timing t101, the controller die CD inputs the header set of 4 bits illustrated in FIG. 11 to the memory die MD in units of 2 bits dividedly over 2 cycles. For example, when the command data Cmd of 8 bits is instructed to be input in the body set, in the header of the first cycle, voltages of the control terminals CA0(ALE) and CA1(CLE) corresponding to, for example, H0 and H1 representing bits of “0” and “0” are set, and are taken into a register (not illustrated) of the logic circuit CTR at a timing (rising edge) at which the control terminal CA_clk(/WE) rises from “L” to “H”. In the header of the second cycle, voltages of the control terminals CA0(ALE) and CA1(CLE) corresponding to, for example, H2 and H3 representing bits of “1” and “1” are set, and are taken into the register (not illustrated) of the logic circuit CTR at a timing (falling edge) at which the control terminal CA_clk(/WE) falls from “H” to “L”.

In the example of FIG. 10, at timing t102 to timing t105, the body set of 8 bits corresponding to the rising edge and the falling edge of the signal input to the control terminal CA_clk(/WE) is input. More specifically, at timing t102 to timing t105, the controller die CD inputs the body set of 8 bits corresponding to the header set of 4 bits to the memory die MD in units of 2 bits dividedly over 4 cycles. For example, the command data Cmd of 8 bits is set to bits of “0” to “7”. In the body (data) of the first cycle, voltages of the control terminals CA0(ALE) and CA1(CLE) corresponding to bits of “1” and “0” are set, and are taken into the register at a timing (rising edge) at which the control terminal CA_clk(/WE) rises from “L” to “H”. In the body (data) of the second cycle, voltages of the control terminals CA0(ALE) and CA1(CLE) corresponding to bits of “3” and “2” are set, and are taken into the register at a timing (falling edge) at which the control terminal CA_clk(/WE) falls from “H” to “L”. In the body of the third to fourth cycles, voltages of the control terminals CA0(ALE) and CA1(CLE) corresponding to bits of “5” and “4” and bits of “7” and “6” are set, and are taken into the register at a timing (rising edge) at which the control terminal CA_clk(/WE) rises and at a timing (falling edge) at which the control terminal CA_clk(/WE) falls, respectively.

As the example of the header set, a case where the command data Cmd is instructed to be input (CMD) in the body set is described. However, the present embodiment is not limited to this example. As illustrated in FIG. 11, the header set may instruct the address data Add to be input (ADD) in the body set. In addition, the header set may instruct data to be output (DOUT) or may instruct data to be input (DIN) in the body set. The output of data (DOUT) includes, for example, output of the status data Stt or the feature data Fd. The input of data (DIN) includes, for example, input of the feature data Fd.

In this way, in the semiconductor memory device according to the present embodiment, when the memory die MD operates in the first mode, the data is input in units of 2 bits through the control terminals CA0(ALE) and CA1(CLE). Accordingly, when the header set of 4 bits and the body set of 8 bits are input, 6 cycles (2 bits×6 cycles) are required in the first mode.

### Operation

Next, the operation of the memory die MD will be described.

The memory die MD is configured to execute the read operation. In the read operation, the user data Dat is read from the memory cell array MCA by the sense amplifier module SAM, and the read user data Dat is transmitted to the latch circuit XDL. In the read operation, the user data Dat read from the memory cell array MCA is transmitted to the latch circuit XDL through the bit line BL and the sense amplifier module SAM.

In addition, the memory die MD is configured to execute the data out operation of the user data Dat. In the data out operation of the user data Dat, the user data Dat in the latch circuit XDL is output to the controller die CD. In the data out operation of the user data Dat, the user data Dat in the latch circuit XDL is output to the controller die CD through the column decoder COLD, the multiplexer MPX, the bus wiring DB, and the input/output control circuit I/O described with reference to FIG. 7.

The memory die MD is configured to execute the status read. In the status read, th status data Stt in the status register STR is output to the controller die CD. In the status read, the status data Stt in the status register STR is output to the controller die CD through the logic circuit CTR.

In addition, the memory die MD is configured to execute the get feature (feature information output operation). In the get feature, the feature data Fd in the feature register FR (FIG. 4) is output to the controller die CD (FIG. 1). In the get feature, the feature data Fd in the feature register FR is output to the controller die CD through the logic circuit CTR.

The memory die MD is configured to execute the set feature. In the set feature, the feature data Fd is input to the feature register FR (FIG. 4). In the set feature, the feature data Fd is input from the controller die CD to the feature register FR through the logic circuit CTR.

### Set Feature in First Mode

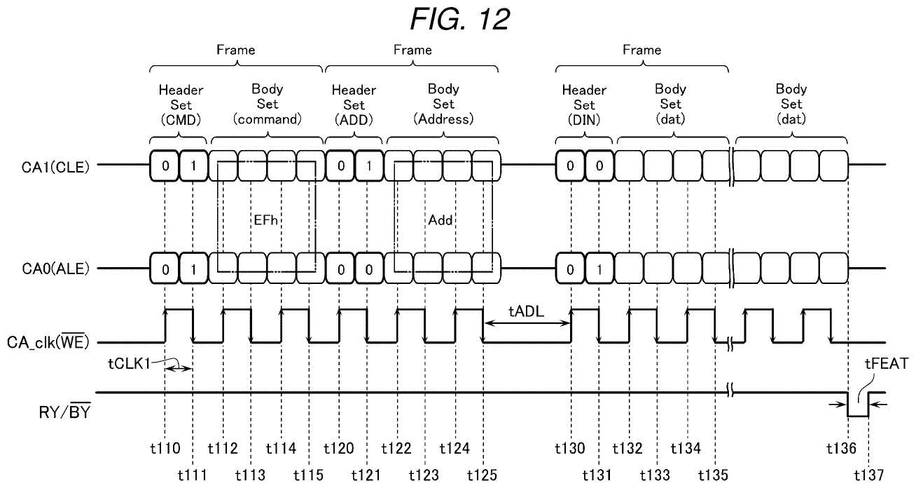

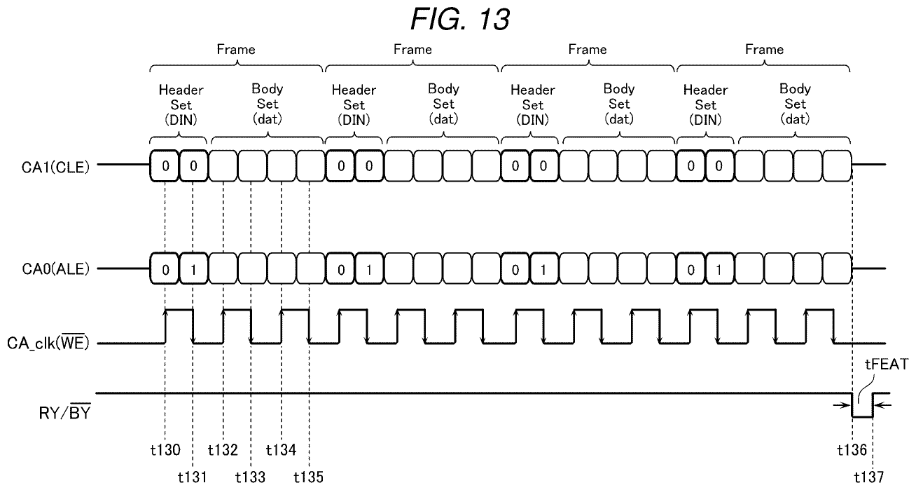

FIGS. 12 and 13 are schematic waveform charts illustrating the input/output signals between the controller die CD and the memory die MD. FIG. 12 illustrates a schematic timing chart when the set feature is executed during the operation in the first mode. In FIG. 12, a part of the waveform is not illustrated. FIG. 13 illustrates the part of the waveform not illustrated in FIG. 12.

Before timing t110 of FIG. 12, although not illustrated in the drawing, the voltage of the control terminal /CE falls from “H” to “L”.

Next, at timing t110 to timing t135, the controller die CD inputs a command set of the set feature to the memory die MD. That is, the controller die CD inputs the command data Cmd for instructing the set feature to the memory die MD at timing t110 to timing t115, inputs the address data Add for designating a feature address (for example, a part of the feature register FR) corresponding to a parameter or the like for the set feature to the memory die MD at timing t120 to timing t125, and inputs the feature data Fd for setting the feature address to the memory die MD at timing t130 to timing t135.

More specifically, at timing t110 to timing t111, the controller die CD inputs a header set that includes a header of the first cycle representing bits of “0” and “0” and a header of the second cycle representing bits of “1” and “1” to the memory die MD through the control terminals CA0(ALE) and CA1(CLE). As illustrated in FIG. 11, the header set instructs the command data Cmd to be input, and is input at a rising edge and a falling edge (timings thereof) of the signal input to the control terminal CA_clk(/WE). In other words, at timing t110 to t111, in a frame corresponding to command data Cdd that make up the command set of the set feature, a portion (information of 4 bits) corresponding to the header set is input to the memory die MD in response to two times of toggling of the signal input to the control terminal CA_clk(/WE).

In addition, at timing t112 to timing t115, the controller die CD inputs command data EFh as the body set to the memory die MD through the control terminals CA0(ALE) and CA1(CLE). The command data “EFh” is the command data Cmd that instructs the set feature. When the command data EFh is input, the set feature is executed in all of the memory dies MD where “L” is input to the control terminal /CE. In other words, at timing t112 to timing t115, in a frame corresponding to the command data Cdd that make up the command set of the set feature, a portion (information of 8 bits) corresponding to the body set is input to the memory die MD in response to four times of toggling of the signal input to the control terminal CA_clk(/WE). For example, an interval between the timing of the rising edge and the timing of the falling edge of the signal input to the control terminal CA_clk(/WE) and an interval between the timing of the falling edge and the timing of the rising edge of the signal input to the control terminal CA_clk(/WE) are periods tCLK1. That is, the toggle interval of the control terminal CA_clk(/WE) is the period tCLK1.

In addition, at timing t120 to timing t121, the controller die CD inputs a header set that includes a header of the first cycle representing bits of “0” and “0” and a header of the second cycle representing bits of “1” and “0” to the memory die MD through the control terminals CA0(ALE) and CA1(CLE). As illustrated in FIG. 11, the header set instructs the address data Add to be input, and is input at the rising edge and the falling edge of the signal input to the control terminal CA_clk(/WE). In other words, at timing t120 to t121, in a frame corresponding to the address data Add that make up the command set of the set feature, a portion (information of 4 bits) corresponding to the header set is input to the memory die MD in response to two times of toggling of the signal input to the control terminal CA_clk(/WE).

In addition, at timing t122 to timing t125, the controller die CD inputs the address data Add as the body set to the memory die MD through the control terminals CA0(ALE) and CA1(CLE). This address data Add is data for specifying a portion of the feature register FR to which the feature data Fd is input (a parameter or the like set in the set feature). In other words, at timing t122 to timing t125, in a frame corresponding to the address data Add that make up the command set of the set feature, a portion (information of 8 bits) corresponding to the body set is input to the memory die MD in response to four times of toggling of the signal input to the control terminal CA_clk(/WE).

In addition, at timing t130 to timing t131, the controller die CD inputs a header set that includes a header of the first cycle representing bits of “0” and “0” and a header of the second cycle representing bits of “0” and “1” to the memory die MD through the control terminals CA0(ALE) and CA1(CLE). As illustrated in FIG. 11, the header set instructs data to be input, and is input at the rising edge and the falling edge of the signal input to the control terminal CA_clk(/WE). In other words, at timing t130 to timing t131, in a frame corresponding to the feature data Fd that make up the command set of the set feature, a portion (information of 4 bits) corresponding to the header set is input to the memory die MD in response to two times of toggling of the signal input to the control terminal CA_clk(/WE).

The controller die CD maintains the signal to be input to the control terminal CA_clk(/WE) at “L” in a period tADL from timing t125 to timing t130. In other words, the controller die CD inputs the frame corresponding to the address data Add that make up the command set of the set feature to the memory die MD, and subsequently suspends the input of the frame corresponding to the feature data Fd to the memory die MD during at least the period tADL. In this period, the signal input to the control terminal CA_clk(/WE) is not toggled. The period tADL is set to ensure appropriate input of the feature data Fd to a designated portion in the feature register FR, for example, after inputting the command data Cmd and the address data Add that make up the command set of the set feature to the memory die MD.

In addition, at timing t132 to timing t135, the controller die CD inputs the feature data Fd as data to the memory die MD. This feature data Fd includes information representing an operating parameter or the like. In the example illustrated in the drawing, at timing t132 to t135, the data of 8 bits×4 cycles that make up the feature data Fd is input. However, the number of cycles may be less than or more than 4.

When the feature data Fd is input, for example, as illustrated in FIG. 13, a frame including both of the header set that instructs data to be input and the body set that configures the feature data Fd may be input multiple times.

In addition, after timing t136, the set feature starts, and the voltage of the terminal RY//BY falls from “H” to “L”.

In addition, at timing t137, the set feature ends, and the voltage of the terminal RY//BY rises from “L” to “H”. In a period tFEAT where the voltage of the terminal RY//BY falls once and then falls once again, the set feature of inputting the feature data Fd to the designated portion in the feature register FR is executed.

### Get Feature in First Mode

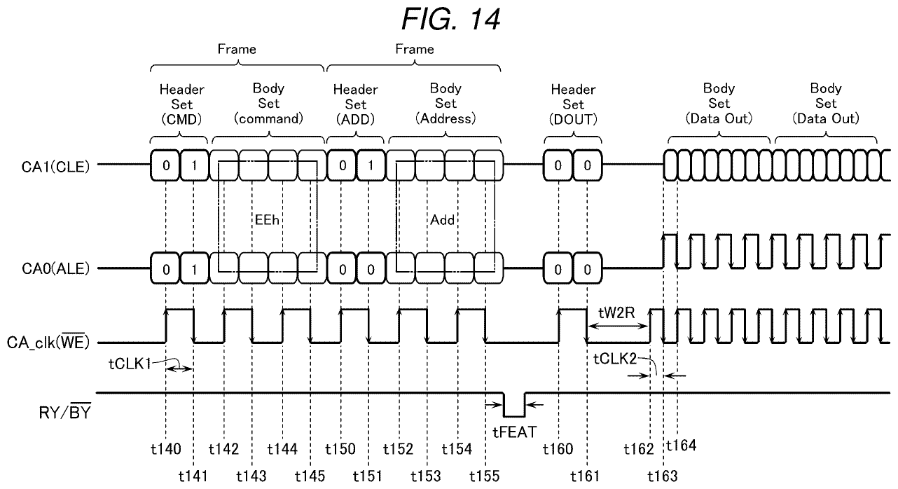

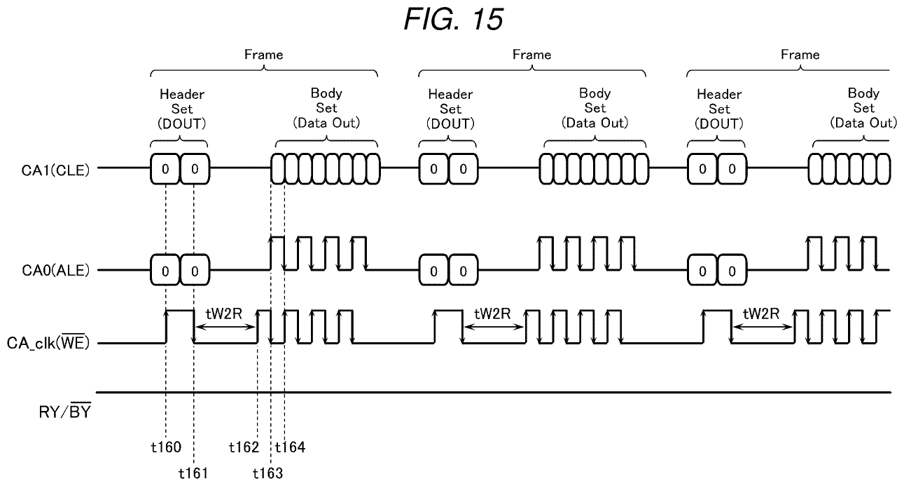

FIGS. 14 and 15 are schematic waveform charts illustrating the input/output signals between the controller die CD and the memory die MD. FIG. 14 illustrates a schematic timing chart when the get feature is executed during the operation in the first mode. FIG. 15 illustrates another example of a part of the waveform illustrated in FIG. 14.

Before timing t140 of FIG. 14, although not illustrated in the drawing, the voltage of the control terminal /CE falls from “H” to “L”.

In the example of FIG. 14, at timing t140 to timing t141, the controller die CD inputs a header set that includes a header of the first cycle representing bits of “0” and “0” and a header of the second cycle representing bits of “1” and “1” to the memory die MD through the control terminals CA0(ALE) and CA1(CLE). As illustrated in FIG. 11, the header set instructs the command data Cmd to be input, and is input at the rising edge and the falling edge of the signal input to the control terminal CA_clk(/WE).

In addition, at timing t142 to timing t145, the controller die CD inputs command data EEh as the body set to the memory die MD through the control terminals CA0(ALE) and CA1(CLE). The command data “EEh” is the command data Cmd that instructs the get feature. When the command data EEh is input, the get feature is executed in all of the memory dies MD where “L” is input to the control terminal /CE.

In addition, at timing t150 to timing t151, the controller die CD inputs a header set that includes a header of the first cycle representing bits of “0” and “0” and a header of the second cycle representing bits of “1” and “0” to the memory die MD through the control terminals CA0(ALE) and CA1(CLE). As illustrated in FIG. 11, the header set instructs the address data Add to be input, and is input at the rising edge and the falling edge of the signal input to the control terminal CA_clk(/WE).

In addition, at timing t152 to timing t155, the controller die CD inputs the address data Add as the body set to the memory die MD through the control terminals CA0(ALE) and CA1(CLE). This address data Add is data for specifying a portion of the feature register FR where the feature data Fd to be output is stored.

After a predetermined period of time from timing t155, in the period tFEAT where the voltage of the terminal RY//BY falls once and then falls once again, for example, the control parameter or the like of the memory die MD is read as the feature data Fd stored in the designated portion in the feature register FR.

In addition, at timing t160 to timing t161, the controller die CD inputs a header set that includes a header of the first cycle representing bits of “0” and “0” and a header of the second cycle representing bits of “0” and “0” to the memory die MD through the control terminals CA0(ALE) and CA1(CLE). As illustrated in FIG. 11, the header set instructs data to be output, and is input at the rising edge and the falling edge of the signal input to the control terminal CA_clk(/WE).

Along with the input of the header set, after a predetermined wait time (after a period tW2R), the controller die CD switches (toggles) the input signal of the control terminal CA_clk(/WE), and designates an output timing of data. More specifically, at timing t160, the controller die CD switches the input signal of the control terminal CA_clk(/WE) from “L” to “H”. In addition, at timing t161, the controller die CD switches the input signal of the control terminal CA_clk(/WE) from “H” to “L”, and then repeats the switching (toggling). As a result, the data output operation starts, and the feature data Fd obtained in the get feature is output. More specifically, in response to the rising edge and the falling edge of the signal input to the control terminal CA_clk(/WE), the feature data Fd is output through the control terminal CA1(CLE) by the output circuit 202 connected thereto in accordance with a rising edge and a falling edge of the timing signal output through CA0(ALE) by the output circuit 202 connected thereto.

More specifically, at timing t162, when the input signal of the control terminal CA_clk(/WE) is switched from “L” to “H”, at timing t163 after a predetermined period of time, the feature data Fd is output from the control terminal CA1(CLE) at the rising edge of the timing signal output from CA0(ALE). In addition, at timing t163, when the input signal of the control terminal CA_clk(/WE) is switched from “H” to “L”, at timing t164 after a predetermined period of time, the feature data Fd is output from the control terminal CA1(CLE) at the falling edge of the timing signal output from CA0(ALE).

For example, an interval between the timing of the rising edge and the timing of the falling edge of the signal input to the control terminal CA_clk(/WE) is a period tCLK2. Likewise, an interval between the timing of the falling edge and the timing of the rising edge of the signal output from the control terminal CA0(ALE) is also the period tCLK2. That is, the toggle interval of the control terminal CA_clk(/WE) is the period tCLK2. The output signal of the control terminal CA0(ALE) rises or falls whenever data of 1 bit is output to the control terminal CA1(CLE). Accordingly, even when “0” is continuously output or “1” is continuously output from the control terminal CA1(CLE), partitions of data can be distinguished.

When the feature data Fd is output, for example, as illustrated in FIG. 14, after inputting the header set that instructs data to be output once, a plurality of body sets that make up the feature data Fd may be continuously output. That is, the input of the header set may be skipped until the output of the feature data Fd ends. In addition, for example, as illustrated in FIG. 15, the body set that make up the feature data Fd may be output once whenever the header set that instructs data to be output is input once.

### Status Read in First Mode

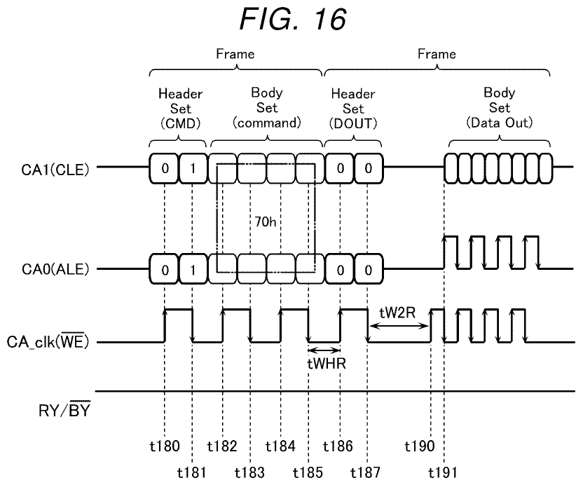

FIG. 16 is a schematic waveform chart illustrating the input/output signals between the controller die CD and the memory die MD. FIG. 16 illustrates a schematic timing chart when the status read is executed during the operation in the first mode.

Before timing t180 of FIG. 16, although not illustrated in the drawing, the voltage of the control terminal /CE falls from “H” to “L”.

In the example of FIG. 16, at timing t180 to timing t181, the controller die CD inputs a header set that includes a header of the first cycle representing bits of “0” and “0” and a header of the second cycle representing bits of “1” and “1” to the memory die MD through the control terminals CA0(ALE) and CA1(CLE). As illustrated in FIG. 11, the header set instructs the command data Cmd to be input, and is input at the rising edge and the falling edge of the signal input to the control terminal CA_clk(/WE).

In addition, at timing t182 to timing t185, the controller die CD inputs command data 70h as the body set to the memory die MD through the control terminals CA0(ALE) and CA1(CLE). The command data “70h” is the command data Cmd that instructs the status read. When the command data 70h is input, the status read is executed, for example, in the memory die MD to which the command set is input right before.

In addition, at timing t186 to timing t187, the controller die CD inputs a header set that includes a header of the first cycle representing bits of “0” and “0” and a header of the second cycle representing bits of “0” and “0” to the memory die MD through the control terminals CA0(ALE) and CA1(CLE). As illustrated in FIG. 11, the header set instructs data to be output, and is input at the rising edge and the falling edge of the signal input to the control terminal CA_clk(/WE).

Along with the input of the header set, after a predetermined wait time (after a period tW2R), the controller die CD switches (toggles) the input signal of the control terminal CA_clk(/WE), and designates an output timing of data. As a result, the data output operation starts, and the status data Stt obtained in the status read is output through the control terminal CA1(CLE) at the rising edge and the falling edge of the timing signal output through CA0(ALE). The output circuit 202 connected to the control terminal CA0(ALE) outputs the timing signal to rise or fall whenever the output circuit 202 connected to the control terminal CA1(CLE) outputs data of 1 bit.

In this way, when the memory die MD operates in the first mode, the data is output in units of 1 bit through the control terminal CA1(CLE). Accordingly, when data of 8 bits is output, 8 cycles (1 bit×8 cycles) are required in the first mode.

### Example of Data Input in Second Mode

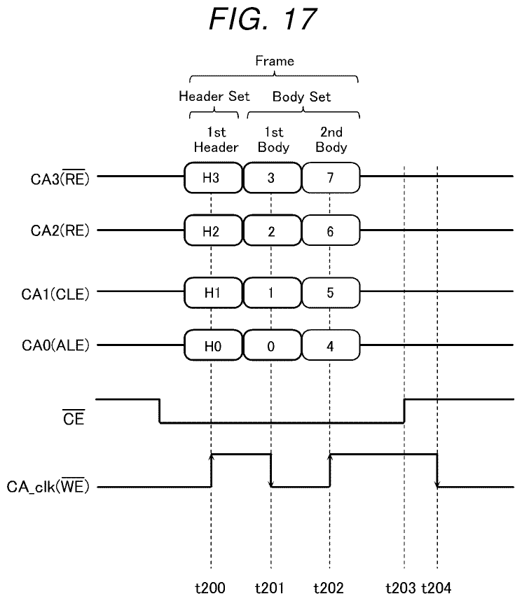

FIG. 17 is a schematic waveform chart illustrating the operation of the memory die MD according to the present embodiment. FIG. 17 illustrates a waveform when the data is input during the operation of the memory die MD in the second mode. In the second mode, in addition to the control terminal CA0(ALE) and the control terminal CA1(CLE), two other terminals are used, for example, for inputting the command data Cmd and the address data Add. More specifically, in the second mode, in addition to the control terminal CA0(ALE) and the control terminal CA1(CLE), the control terminals /RE and RE are used for inputting the command data Cmd and the address data Add, for outputting the status data Stt, and for inputting and outputting the feature data Fd. In the description of the second mode, the control terminals /RE and RE may also be referred to as a control terminal CA2(RE) and a control terminal CA3(/RE). It can be said that the second mode is a mode in which the four terminals are used, for example, for inputting the command data Cmd and the address data Add.

In the example of FIG. 17, before timing t200, the voltage of the control terminal /CE falls from “H” to “L”.

In addition, at timing t200, the controller die CD inputs a header set of 4 bits including a header of one cycle (only the first header) to the memory die MD through the control terminals CA0(ALE), CA1(CLE), CA2(RE), and CA3(/RE). For example, this header set may be a header set that instructs the command data Cmd to be input (CMD) in the body set, may be a header set that instructs the address data Add to be input (ADD) in the body set, or may be a header set that instructs the data to be input (DIN) in the body set. In the second mode, a header set of a frame that is initially input is input at the rising edge of the signal input to the control terminal CA_clk(/WE).

In addition, in the example of FIG. 17, at timing t201 to timing t202, the body set of 8 bits corresponding to the falling edge and the rising edge of the signal input to the control terminal CA_clk(/WE) is input. More specifically, at timing t201 to timing t202, the controller die CD inputs the body set of 8 bits corresponding to the header set of 4 bits to the memory die MD in units of 4 bits dividedly over 2 cycles. For example, the command data Cmd of 8 bits is set to bits of “0” to “7”. First, in the body (data) of the first cycle, voltages of the control terminals CA0(ALE), CA1(CLE), CA2(RE), and CA3(/RE) corresponding to bits of “0”, “1”, “2”, and “3” are set, and are taken into the register at a timing (falling edge) at which the control terminal CA_clk(/WE) falls from “H” to “L”. In the body (data) of the second cycle, voltages of the control terminals CA0(ALE), CA1(CLE), CA2(RE), and CA3(/RE) corresponding to bits of “4”, “5”, “6”, and “7” are set, and are taken into the register at a timing (rising edge) at which the control terminal CA_clk(/WE) rises from “L” to “H”.

Next, when another frame is input, a header set of the following frame is input at the falling edge of the signal input to the control terminal CA_clk(/WE), and a body set of the following frame is input at the rising edge and the falling edge of the signal input to the control terminal CA_clk(/WE).

Next, when another frame is not input, the control die allows the voltage of the control terminal /CE to rise from “L” to “H” (timing t203 of FIG. 17). Next, the control die allows (resets) the signal input to the control terminal CA_clk(/WE) to fall from “H” to “L”. As a result, the first cycle of the header set of the frame that is initially input after the control die subsequently allows the voltage of the control terminal /CE to fall from “H” to “L” is input at the rising edge of the signal input to the control terminal CA_clk(/WE). In other words, when odd-numbered frames are input in the second mode such that the frame input ends in a state where the signal input to the control terminal CA_clk(/WE) is “H”, the control die resets the signal input to the control terminal CA_clk(/WE) a predetermined period of time after allowing the voltage of the control terminal /CE to rise from “L” to “H”.

In this way, when the memory die MD operates in the second mode, the data can input in units of 4 bits through the control terminals CA0(ALE), CA1(CLE), CA2(RE), and CA3(/RE). Accordingly, the input of the header set of 4 bits and the body set of 8 bits can be executed in 3 cycles (4 bits×3 cycles) in the second mode. That is, in the second mode, as compared to the first mode, the number of cycles required for the input of the header set of 4 bits and the body set of 8 bits can be reduced, and the speed of the operation can be increased.

Examples of the two control terminals CA2 and CA3 used in addition to the control terminals CA0(ALE) and CA1(CLE) in the second mode are not limited to the control terminals RE and /RE. As the control terminals CA2 and CA3, for example, the terminal RY//BY and the control terminal /WP may be used instead of the control terminals RE and /RE. In addition, the control terminal /RE may be used as the control terminal CA2, and the control terminal RE may be used as the control terminal CA3.

### Example of Data Input in Third Mode

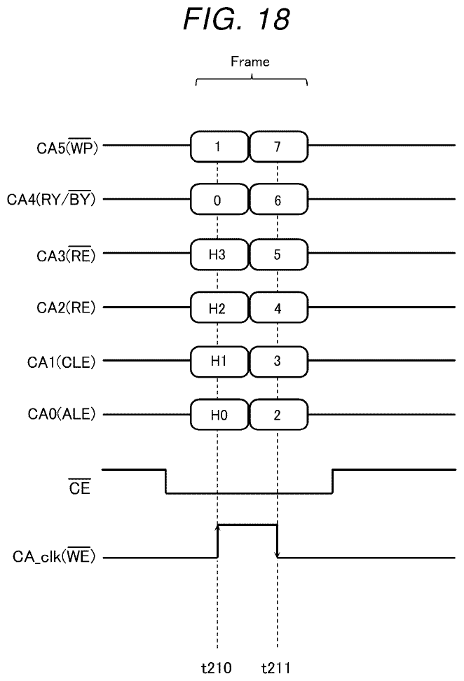

FIG. 18 is a schematic waveform chart illustrating the operation of the memory die MD according to the present embodiment. FIG. 18 illustrates a waveform when the data is input during the operation of the memory die MD in the third mode. In the third mode, in addition to the control terminal CA0(ALE) and the control terminal CA1(CLE), four other terminals are used, for example, for inputting the command data Cmd and the address data Add. More specifically, in the third mode, in addition to the control terminal CA0(ALE) and the control terminal CA1(CLE), the control terminals /RE, RE, and /WP, and the terminal RY//BY are used for inputting the command data Cmd and the address data Add, for outputting the status data Stt, and for inputting and outputting the feature data Fd. In the description of the third mode, the control terminals /RE, RE, and /WP, and the terminal RY//BY may also be referred to as the control terminal CA2(RE), the control terminal CA3(/RE), a control terminal CA4(RY//BY), and a control terminal CA5(/WP). It can be said that the third mode is a mode in which the six terminals are used, for example, for inputting the command data Cmd and the address data Add.

In the example of FIG. 18, before timing t210, the voltage of the control terminal /CE falls from “H” to “L”.

In addition, at timing t210, the controller die CD inputs a header set of 4 bits to the memory die MD through the control terminals CA0(ALE), CA1(CLE), CA2(RE), and CA3(/RE). For example, this header set may be a header set that instructs the command data Cmd to be input (CMD) in the body set, may be a header set that instructs the address data Add to be input (ADD) in the body set, or may be a header set that instructs the data to be input (DIN) in the body set. In addition, a body of 2 bits that is a part of the body set (data) of 8 bits is input to the control terminals CA4(RY//BY) and CA5(/WP). These data are input at the rising edge of the signal input to the control terminal CA_clk(/WE).

In addition, in the example of FIG. 18, at timing t211, the controller die CD inputs body of 2 bits that is a part of the body set (data) of 8 bits to the memory die MD through the control terminals CA0(ALE), CA1(CLE), CA2(RE), and CA3(/RE). This data is taken into the register at a timing at which the control terminal CA_clk(/WE) falls from “H” to “L”.

In this way, when the memory die MD operates in the third mode, the data can be input in units of 6 bits through the control terminals CA0(ALE), CA1(CLE), CA2(RE), CA3(/RE), CA4(RY//BY), and CA5(/WP). Accordingly, the input of the header set of 4 bits and the body set of 8 bits can be executed in 2 cycles (6 bits×2 cycles) in the third mode. That is, in the third mode, as compared to the first mode or the second mode, the number of cycles required for the input of the header set of 4 bits and the body set of 8 bits can be reduced, and the speed of the operation can be increased.

In the third mode, any one of the six control terminals CA2, CA3, CA4, and CA5 used in addition to the control terminals CA0(ALE) and CA1(CLE) may be replaced with any one of the terminal RY//BY, the control terminal RE, the control terminal /RE, and the control terminal /WP.

### Example of Data Input in Fourth Mode

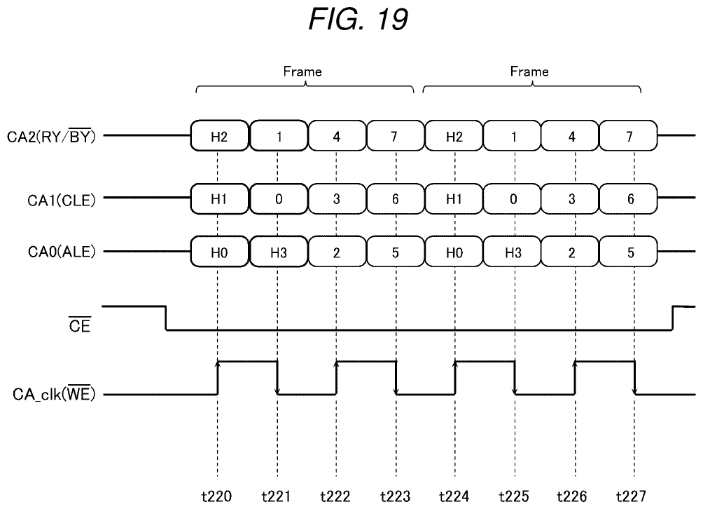

FIG. 19 is a schematic waveform chart illustrating the operation of the memory die MD according to the present embodiment. FIG. 19 illustrates a waveform when the data is input during the operation of the memory die MD in the fourth mode. In the fourth mode, in addition to the control terminal CA0(ALE) and the control terminal CA1(CLE), one other terminal is used, for example, for inputting the command data Cmd and the address data Add. More specifically, in the fourth mode, in addition to the control terminal CA0(ALE) and the control terminal CA1(CLE), the terminal RY//BY is used for inputting the command data Cmd and the address data Add, for outputting the status data Stt, and for inputting and outputting the feature data Fd. In the description of the fourth mode, the terminal RY//BY will also be referred to as the control terminal CA2(RY//BY). It can be said that the fourth mode is a mode in which the three terminals are used, for example, for inputting the command data Cmd and the address data Add.

In the example of FIG. 19, before timing t220, the voltage of the control terminal /CE falls from “H” to “L”.

In addition, at timing t220, the controller die CD inputs a header of 3 bits that is a part of the header set of 4 bits to the memory die MD through the control terminals CA0(ALE), CA1(CLE), and CA2(RY//BY). For example, this header set may be a header set that instructs the command data Cmd to be input (CMD) in the body set, may be a header set that instructs the address data Add to be input (ADD) in the body set, or may be a header set that instructs the data to be input (DIN) in the body set. These headers are input at the rising edge of the signal input to the control terminal CA_clk(/WE).

In addition, at timing t221, the controller die CD inputs a header of 1 bit that is a part of the header set of 4 bits to the memory die MD through the control terminal CA0(ALE). In addition, a body of 2 bits that is a part of the body set (data) of 8 bits is input through the control terminals CA1(CLE) and CA2(RY//BY). These data are input at the falling edge of the signal input to the control terminal CA_clk(/WE).

In addition, at timing t222 and t223, the controller die CD inputs a body that is a part of the body set (data) of 8 bits to the memory die MD through the control terminals CA0(ALE), CA1(CLE), and CA2(RY//BY) in units of 3 bits. These data are input at the rising edge and the falling edge of the signal input to the control terminal CA_clk(/WE).

In addition, in the example of FIG. 19, at timing t224 to timing t227, the controller die CD inputs a frame to the memory die MD as in the operation at timing t220 to timing t223.

In this way, when the memory die MD operates in the fourth mode, the data can be input in units of 3 bits through the control terminals CA0(ALE), CA1(CLE), and CA2(RY//BY). Accordingly, the input of the header set of 4 bits and the body set of 8 bits can be executed in 4 cycles (3 bits×4 cycles) in the fourth mode. That is, in the fourth mode, as compared to the first mode, the number of cycles required for the input of the header set of 4 bits and the body set of 8 bits can be reduced, and the speed of the operation can be increased.

The example of the one control terminal CA2 used in addition to the control terminals CA0(ALE) and CA1(CLE) in the fourth mode is not limited to the control terminal RY//BY. As the control terminal CA2, for example, any one of the control terminals RE and /RE or the control terminal /WP may be used.

### Example of Data Input in Fifth Mode

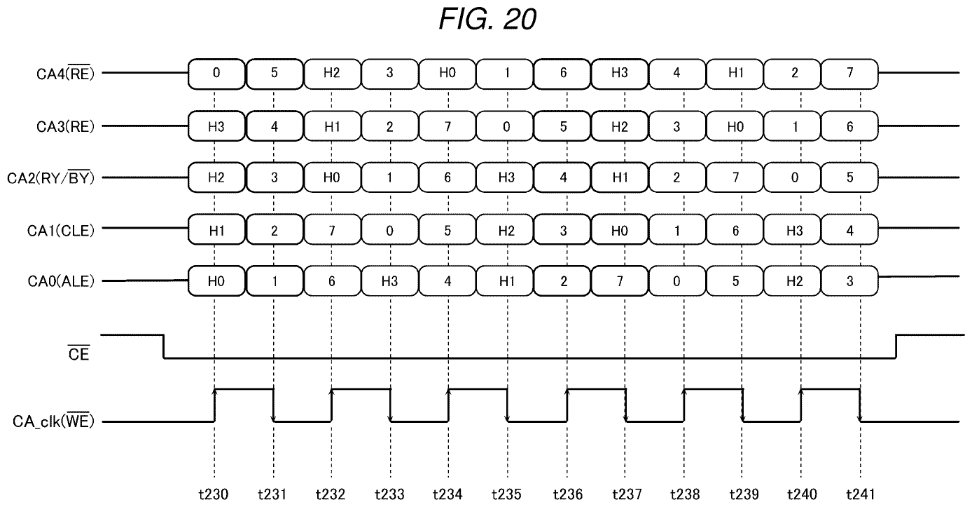

FIG. 20 is a schematic waveform chart illustrating the operation of the memory die MD according to the present embodiment. FIG. 20 illustrates a waveform when the data is input during the operation of the memory die MD in the fifth mode. In the fifth mode, in addition to the control terminal CA0(ALE) and the control terminal CA1(CLE), three other terminals are used, for example, for inputting the command data Cmd and the address data Add. More specifically, in the fifth mode, in addition to the control terminal CA0(ALE) and the control terminal CA1(CLE), the control terminals /RE and RE, and the terminal RY//BY are used for inputting the command data Cmd and the address data Add, for outputting the status data Stt, and for inputting and outputting the feature data Fd. In the description of the fifth mode, the terminal RY//BY and the control terminals RE and /RE will also be referred to as control terminals CA2(RY//BY), CA3(RE), and CA4(/RE). It can be said that the fifth mode is a mode in which the five terminals are used, for example, for inputting the command data Cmd and the address data Add.

In the example of FIG. 20, before timing t230, the voltage of the control terminal /CE falls from “H” to “L”.

In addition, at timing t230, the controller die CD inputs a header set of 4 bits to the memory die MD through the control terminals CA0(ALE), CA1(CLE), CA2(RY//BY), and CA3(RE). For example, this header set may be a header set that instructs the command data Cmd to be input (CMD) in the body set, may be a header set that instructs the address data Add to be input (ADD) in the body set, or may be a header set that instructs the data to be input (DIN) in the body set. In addition, a body of 1 bit that is a part of the body set (data) of 8 bits is input to the control terminals CA4(/RE). These data are input at the rising edge of the signal input to the control terminal CA_clk(/WE).

In addition, at timing t231, the controller die CD inputs a body of 5 bits that is a part of the body set (data) of 8 bits to the memory die MD through the control terminals CA0(ALE), CA1(CLE), CA2(RY//BY), CA3(RE), and CA4(/RE). These data are input at the rising edge of the signal input to the control terminal CA_clk(/WE).

In addition, at timing t232, the controller die CD inputs a body of 2 bits that is a part of the body set (data) of 8 bits to the memory die MD through the control terminals CA0(ALE) and CA1(CLE). In addition, a header of 3 bits that is a part of the header set in the next frame is input to the control terminals CA2(RY//BY), CA3(RE), and CA4(/RE).

In this way, in the example of FIG. 20, data of 5 bits input at timing t232, timing t234, timing t237, and timing t239 includes data in two frames that are continuously input.

In this way, when the memory die MD operates in the fifth mode, the data can be input in units of 5 bits through the control terminals CA0(ALE), CA1(CLE), CA2(RY//BY), CA3(RE), and CA4(/RE). Accordingly, the input of the header set of 4 bits and the body set of 8 bits can be executed in 2.4 cycles (5 bits×2.4 cycles) in the fifth mode. That is, in the fifth mode, as compared to the first mode, the second mode, or the fourth mode, the number of cycles required for the input of the header set of 4 bits and the body set of 8 bits can be reduced, and the speed of the operation can be increased.

When the memory die MD operates in the fifth mode, a method of inputting the data in units of 5 bits through the control terminals CA0(ALE), CA1(CLE), CA2(RY//BY), CA3(RE), and CA4(/RE) is not limited to the case described using FIG. 20. Hereinafter, another example of the data input in the fifth mode will be described.

### Another Example of Header Set Input in Fifth Mode

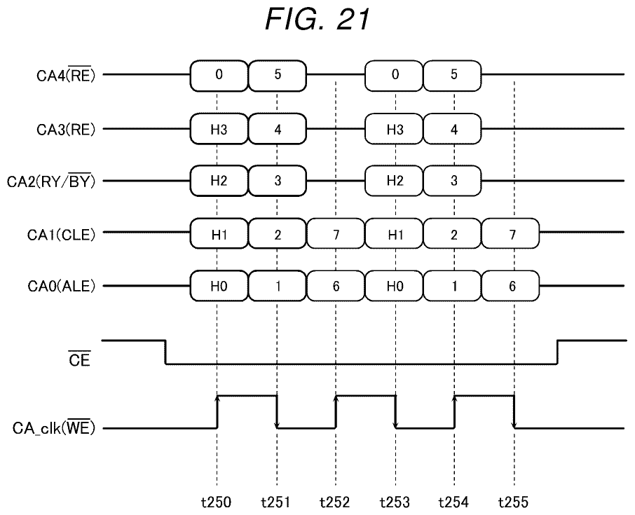

FIG. 21 is a schematic waveform chart illustrating the operation of the memory die MD according to the present embodiment. FIG. 21 illustrates a waveform when the data is input during the operation of the memory die MD in the fifth mode.

The operation illustrated in FIG. 21 is executed basically using the same method as that in the operation described with reference to FIG. 20. It should be noted that, in the example of FIG. 21, at timing t250 to timing t252, data input over 3 cycles includes only data in one frame. In the example of FIG. 21, data of 3 bits input through the control terminals CA2(RY//BY), CA3(RE), and CA4(/RE) in the third cycle is invalid data.

When the memory die MD operates as described above, the data can be input in units of 5 bits through the control terminals CA0(ALE), CA1(CLE), CA2(RY//BY), CA3(RE), and CA4(/RE). Accordingly, the input of the header set of 4 bits and the body set of 8 bits can be executed in 3 cycles. Even in this method, as compared to the first mode, the speed of the operation can be increased.

In this way, when the memory die MD operates as described above, the data can b input in units of 5 bits through the control terminals CA0(ALE), CA1(CLE), CA2(RY//BY), CA3(RE), and CA4(/RE). Accordingly, the input of the header set of 4 bits and the body set of 8 bits can be executed in 3 cycles (5 bits×3 cycles) in the operation of the other example of the fifth mode. That is, in the operation of the other example of the fifth mode, as compared to the first mode or the fourth mode, the number of cycles required for the input of the header set of 4 bits and the body set of 8 bits can be reduced, and the speed of the operation can be increased.

Examples of the three control terminals CA2, CA3, and CA4 used in addition to the control terminals CA0(ALE) and CA1(CLE) in the fifth mode are not limited to the terminal RY//BY, the control terminal RE, and the control terminal /RE. As any one of the control terminals CA2, CA3, and CA4, the control terminal /WP may be used instead of any one of the terminal RY//BY, the control terminal RE, and the control terminal /RE.

### Example of Data Output in Second Mode

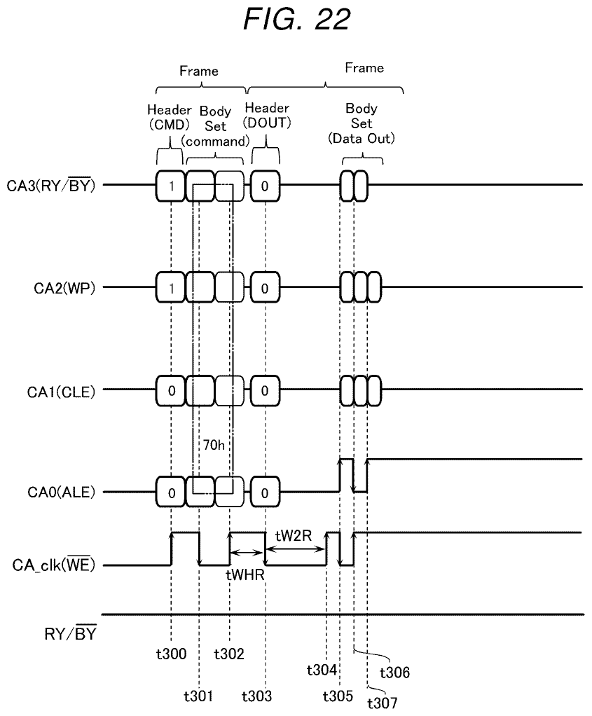

FIG. 22 is a schematic waveform chart illustrating the input/output signals between the controller die CD and the memory die MD according to the present embodiment. FIG. 22 illustrates a schematic timing chart when the status read is executed during the operation of the memory die MD in the second mode. FIG. 22 illustrates an example where, when the memory die MD operates in the second mode, in addition to the control terminal CA0(ALE) and the control terminal CA1(CLE), the terminal RY//BY and the control terminal /WP are used for inputting and outputting data as control terminals CA2(/WP) and CA3(RY//BY).

An operation that is executed until timing t302 among the operations illustrated in FIG. 22 is substantially the same as the operation that is executed until timing t202 among the operations described with reference to FIG. 17. It should be noted that, at timing t300 of FIG. 22, a header set that instructs the command data Cmd to be input (CMD) in the body set is input. In addition, at timing t301 and timing t302 of FIG. 22, the command data Cmd (command data 70h) for executing the status read is input.

In addition, at timing t303 after a period tWHR from timing t302, the controller die CD inputs a header set including a header of one cycle representing bits of “0”, “0”, “0”, and “0” to the memory die MD through the control terminals CA0(ALE), CA1(CLE), CA2(/WP), and CA3(RY//BY). This header set instructs data to be output (DOUT) in the body set as illustrated in FIG. 11.

Along with the input of the header set, from timing t304 after a predetermined wait time (after a period tW2R), the controller die CD switches (toggles) the input signal of the control terminal CA_clk(/WE), and designates an output timing of data. As a result, the data output operation starts, and the status data Stt obtained in the status read is output through the control terminals CA1(CLE), CA2(/WP), and CA3(RY//BY) at the rising edge and the falling edge of the output signal of the control terminal CA0(ALE) after timing t305. The output signal of the control terminal CA0(ALE) is a strobe signal having the same frequency as the control terminal CA_clk(/WE). At the rising edge and the falling edge of the output signal of the control terminal CA0(ALE), data of 6 bits is output in units of 3 bits through the control terminals CA1(CLE), CA2(/WP), and CA3(RY//BY), and then data of 2 bits is output through the control terminals CA1(CLE) and CA2(/WP).

More specifically, at timing t304, the controller die CD switches the input signal o the control terminal CA_clk(/WE) from “L” to “H”. In addition, at timing t305, the controller die CD switches the input signal of the control terminal CA_clk(/WE) from “H” to “L”, and then repeats the switching (toggling) until the output of the status data Stt is completed.

At timing t305 to timing t306, at the rising edge and the falling edge of the output signal of the control terminal CA0(ALE), the body (data) of 6 bits is output in units of 3 bits through the control terminals CA1(CLE), CA2(/WP), and CA3(RY//BY).

At timing t307, at the rising edge of the output signal of the control terminal CA0(ALE), the body (data) of 2 bits is output through the control terminals CA1(CLE) and CA2(/WP).

In this way, when the memory die MD operates in the second mode, the data can output in units of 3 bits through the control terminals CA1(CLE), CA2(/WP), and CA3(RY//BY). Accordingly, the output of the data of 8 bits can be executed in 2.66 cycles in the second mode. That is, in the second mode, as compared to the first mode, the number of cycles required for the output of the data of 8 bits can be reduced, and the speed of the operation can be increased.

### Example of Data Output in Third Mode

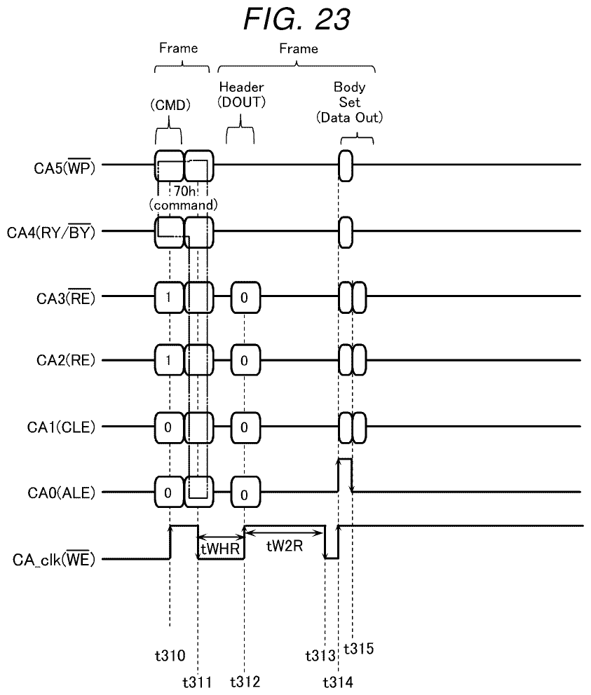

FIG. 23 is a schematic waveform chart illustrating the input/output signals between the controller die CD and the memory die MD according to the present embodiment. FIG. 23 illustrates a schematic timing chart when the status read is executed during the operation of the memory die MD in the third mode.

An operation that is executed until timing t311 among the operations illustrated in FIG. 23 is substantially the same as the operation that is executed until timing t211 among the operations described with reference to FIG. 18. It should be noted that, at timing t310 of FIG. 23, a header set that instructs the command data Cmd to be input (CMD) in the body set is input. In addition, at timing t310 and timing t311 of FIG. 23, the command data Cmd (command data 70h) for executing the status read is input.

In addition, at timing t312 after the period tWHR from timing t311, the controller die CD inputs a header set including a header of one cycle representing bits of “0”, “0”, “0”, and “0”, to the memory die MD through the control terminals CA0(ALE), CA1(CLE), CA2(RE), and CA3(/RE). This header set instructs data to be output (DOUT) in the body set as illustrated in FIG. 11.

Along with the input of the header set, from timing t313 after a predetermined wait time (after a period tW2R), the controller die CD switches (toggles) the input signal of the control terminal CA_clk(/WE), and designates an output timing of data. As a result, the data output operation starts, and the status data Stt obtained in the status read is output through the control terminals CA1(CLE), CA2(RE), CA3(/RE), CA4(RY//BY), and CA4(/WP) at the rising edge and the falling edge of the output signal of CA0(ALE) after timing t314. The output signal of the control terminal CA0(ALE) is a strobe signal having the same frequency as the signal input to the control terminal CA_clk(/WE). At the rising edge and the falling edge of the output signal of the control terminal CA0(ALE), data of 5 bits is output through the control terminals CA1(CLE), CA2(RE), CA3(/RE), CA4(RY//BY), and CA4(/WP), and then data of 3 bits is output through the control terminals CA1(CLE), CA2(RE), and CA3(/RE).

More specifically, at timing t313, the controller die CD switches the input signal o the control terminal CA_clk(/WE) from “H” to “L”. In addition, at timing t314, the controller die CD switches the input signal of the control terminal CA_clk(/WE) from “L” to “H”.

At timing t314, at the rising edge of the output signal of the control terminal CA0(ALE), the body (data) of 6 bits is output through the control terminals CA1(CLE), CA2(RE), CA3(/RE), CA4(RY//BY), and CA4(/WP).

At timing t315, at the falling edge of the output signal of the control terminal CA0(ALE), the body (data) of 3 bits is output through the control terminals CA1(CLE), CA2(/WP), and CA3(/RE).

In this way, when the memory die MD operates in the third mode, the data can be output in units of 5 bits through the control terminals CA1(CLE), CA2(RE), CA3(/RE), CA4(RY//BY), and CA5(/WP). Accordingly, the output of the data of 8 bits can be executed in 1.6 cycles (5 bits×1.6 cycles) in the third mode. That is, in the third mode, as compared to the first mode and the second mode, the number of cycles required for the output of the data of 8 bits can be reduced, and the speed of the operation can be increased.

### Example of Data Output in Fourth Mode

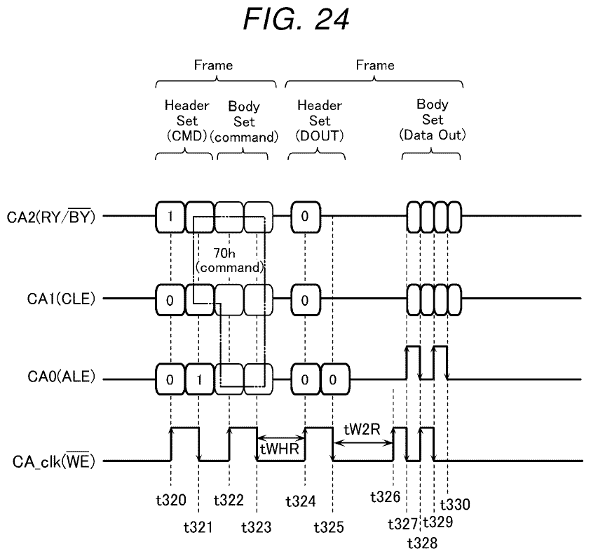

FIG. 24 is a schematic waveform chart illustrating the input/output signals between the controller die CD and the memory die MD according to the present embodiment. FIG. 24 illustrates a schematic timing chart when the status read is executed during the operation of the memory die MD in the fourth mode.

An operation that is executed until timing t323 among the operations illustrated in FIG. 24 is substantially the same as the operation that is executed until timing t223 among the operations described with reference to FIG. 19. It should be noted that, at timing t320 and timing t321 of FIG. 24, a header set that instructs the command data Cmd to be input (CMD) in the body set is input. In addition, at timing t321 to timing t323 of FIG. 24, the command data Cmd (command data 70h) for executing the status read is input.

In addition, at timing t324 after the period tWHR from timing t323, the controller die CD inputs a header of 3 bits that is a part of the header set of 4 bits to the memory die MD through the control terminals CA0(ALE), CA1(CLE), and CA2(RY//BY). This header set instructs data to be output (DOUT) in the body set as illustrated in FIG. 11. These headers are input at the rising edge of the signal input to the control terminal CA_clk(/WE).

In addition, at timing t325, the controller die CD inputs a header of 1 bit that is a part of the header set of 4 bits to the memory die MD through the control terminal CA0(ALE). This data is input at the falling edge of the signal input to the control terminal CA_clk(/WE).

Along with the input of the header set, from timing t326 after a predetermined wait time (after a period tW2R), the controller die CD switches (toggles) the input signal of the control terminal CA_clk(/WE), and designates an output timing of data. As a result, the data output operation starts, and the status data Stt obtained in the status read is output through the control terminals CA1(CLE) and CA2(RY//BY) at the rising edge and the falling edge of the output signal of CA0(ALE) after timing t327. The output signal of the control terminal CA0(ALE) is a strobe signal having the same frequency as the control terminal CA_clk(/WE). At the rising edge and the falling edge of the output signal of the control terminal CA0(ALE), data of 8 bits is output in units of 2 bits through the control terminals CA1(CLE) and CA2(RY//BY).

More specifically, at timing t326, the controller die CD switches the input signal o the control terminal CA_clk(/WE) from “L” to “H”. In addition, at timing t327, the controller die CD switches the input signal of the control terminal CA_clk(/WE) from “H” to “L”, and then repeats the switching (toggling) until the output of the status data Stt is completed.

At timing t327 to timing t330, at the rising edge and the falling edge of the output signal of the control terminal CA0(ALE), the body (data) of 8 bits is output in units of 2 bits through the control terminals CA1(CLE) and CA2(RY//BY).

In this way, when the memory die MD operates in the fourth mode, the data can be output in units of 2 bits through the control terminals CA1(CLE) and CA2(RY//BY). Accordingly, the output of the data of 8 bits can be executed in 4 cycles in the fourth mode. That is, in the fourth mode, as compared to the first mode, the number of cycles required for the output of the data of 8 bits can be reduced, and the speed of the operation can be increased.

### Example of Data Output in Fifth Mode

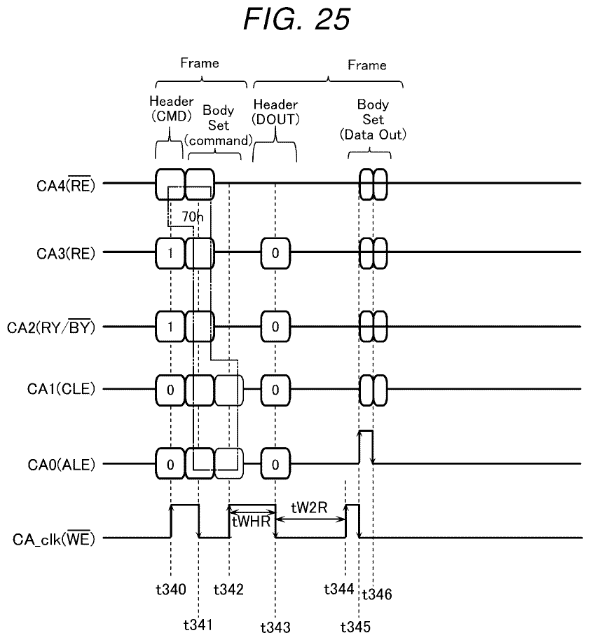

FIG. 25 is a schematic waveform chart illustrating the input/output signals between the controller die CD and the memory die MD according to the present embodiment. FIG. 25 illustrates a schematic timing chart when the status read is executed during the operation of the memory die MD in the third mode.

An operation that is executed until timing t342 among the operations illustrated in FIG. 25 is substantially the same as the operation that is executed until timing t232 among the operations described with reference to FIG. 20. It should be noted that, at timing t340 of FIG. 25, a header set that instructs the command data Cmd to be input (CMD) in the body set is input. In addition, at timing t340 to timing t342 of FIG. 25, the command data Cmd (command data 70h) for executing the status read is input.

In addition, at timing t343 after the period tWHR from timing t342, the controller die CD inputs a header set including a header of one cycle representing bits of “0”, “0”, “0”, and “0”, to the memory die MD through the control terminals CA0(ALE), CA1(CLE), CA2(RY//BY), and CA3(RE). This header set instructs data to be output (DOUT) in the body set as illustrated in FIG. 11.

Along with the input of the header set, from timing t344 after a predetermined wait time (after a period tW2R), the controller die CD switches (toggles) the input signal of the control terminal CA_clk(/WE), and designates an output timing of data. As a result, the data output operation starts, and the status data Stt obtained in the status read is output through the control terminals CA0(ALE), CA1(CLE), CA2(RY//BY), CA3(RE), and CA4(/RE) at the rising edge and the falling edge of the output signal of CA0(ALE) after timing t345. The output signal of the control terminal CA0(ALE) is a strobe signal having the same frequency as the control terminal CA_clk(/WE). At the rising edge and the falling edge of the output signal of the control terminal CA0(ALE), data of 8 bits is output in units of 4 bits through the control terminals CA1(CLE), CA2(RY//BY), CA3(RE), and CA4(/RE).

More specifically, at timing t344, the controller die CD switches the input signal o the control terminal CA_clk(/WE) from “L” to “H”. In addition, at timing t345, the controller die CD switches the input signal of the control terminal CA_clk(/WE) from “H” to “L”, and then repeats the switching (toggling) until the output of the status data Stt is completed.

At timing t345, at the rising edge of the output signal of the control terminal CA0(ALE), the body (data) of 4 bits is output through the control terminals CA1(CLE), CA2(RY//BY), CA3(RE), and CA4(/RE).

In addition, at timing t346, at the falling edge of the output signal of the control terminal CA0(ALE), the body (data) of 4 bits is output through the control terminals CA1(CLE), CA2(RY//BY), CA3(RE), and CA4(/RE).

In this way, when the memory die MD operates in the fifth mode, the data can be output in units of 4 bits through the control terminals CA1(CLE), CA2(RY//BY), CA3(RE), and CA4(/RE). Accordingly, the output of the data of 8 bits can be executed in 2 cycles in the fifth mode. That is, in the fifth mode, as compared to the first mode, the second mode, and the fourth mode, the number of cycles required for the output of the data of 8 bits can be reduced, and the speed of the operation can be increased.

### Use of Each of Terminals

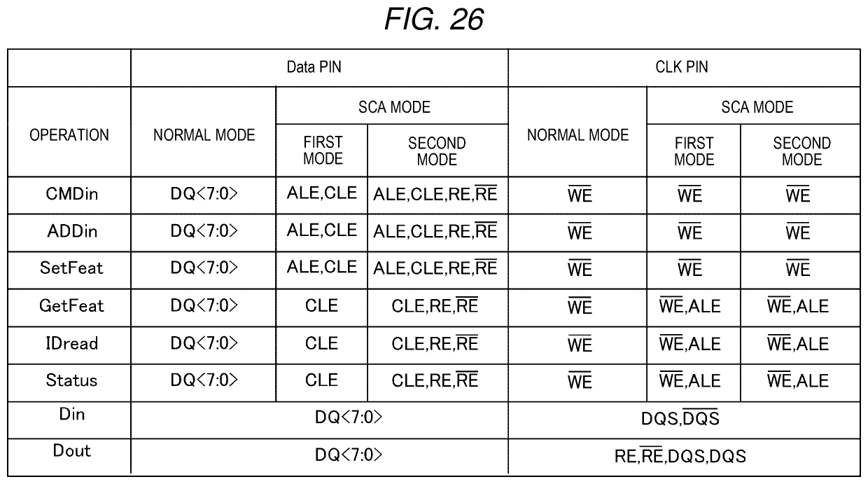

FIG. 26 is a table illustrating use of a signal input/output terminal and a control terminal in the memory die MD. In FIG. 26, in the normal mode (non-SCA mode) other than the first to fifth modes, the first mode (standard SCA mode), and the second mode (the SCA mode other than the standard SCA mode; the SCA mode according to the present embodiment), a signal input/output terminal and a control terminal used as a Data pin and a CLK pin are illustrated.

CMDin of FIG. 26 represents input of the command data Cmd. In addition, ADDin represents input of the address data Add. In addition, SetFeat represents input of the feature data Fd. In the normal mode, the controller die CD inputs the command data Cmd, the address data Add, and the feature data Fd to the memory die MD through the data signal input/output terminals DQ<7:0>. Meanwhile, in the first mode, the controller die CD inputs the command data Cmd, the address data Add, and the feature data Fd to the memory die MD through the control terminals ALE and CLE. Further, in the second mode, the controller die CD inputs the command data Cmd, the address data Add, and the feature data Fd to the memory die MD through the control terminals ALE, CLE, /RE, and RE. In any of the modes, the input of data is executed at a timing of rising of a signal input to the control terminal /WE.

GetFeat of FIG. 26 represents output of the feature data Fd. In addition, IDRead represents output of ID information such as an ID or a manufacturing lot number from the memory die MD. In addition, Status represents output of the status data Stt. In the normal mode, the memory die MD outputs the feature data Fd, the ID information, and the status data Stt to the controller die CD through the data signal input/output terminals DQ<7:0>. Meanwhile, in the first mode, the memory die MD outputs the feature data Fd, the ID information, and the status data Stt to the controller die CD through the control terminal CLE. Further, in the second mode, the memory die MD inputs the feature data Fd, the ID information, and the status data Stt to the controller die CD through the control terminals CLE, /RE, and RE. In any of the modes, the output of data is executed in response to rising of the signal input to the control terminal /WE. In addition, in the first mode and the second mode, a strobe signal representing a partition position of data is output from the control terminal ALE.

Din of FIG. 26 represents input of the user data Dat. In addition, Dout represents output of the user data Dat. In any of the modes, the controller die CD inputs the user data Dat to the memory die MD through the data signal input/output terminals DQ<7:0>. The input of the user data Dat is executed at a timing of switching of the data strobe signal input/output terminals DQS and /DQS. In addition, in any of the modes, the memory die MD outputs the user data Dat to the controller die CD through the data signal input/output terminals DQ<7:0>. The output of the user data Dat is executed at a timing of switching of the control terminals /RE and RE. In addition, the strobe signal representing the partition position of data is output from the data strobe signal input/output terminals DQS and /DQS.

During the data out operation of the user data Dat, the control terminals /RE and RE are used. Accordingly, when the memory die MD according to the present embodiment operates in the second mode, during the execution of the data out operation (Dout), the control terminals /RE and RE cannot be used for inputting the command data Cmd, the address data Add, and the like to the logic circuit CTR and outputting the feature data Fd, the status data Stt, and the like from the logic circuit CTR. When the control terminals /RE and RE are used as the control terminals CA2 and CA3 in the second mode, the operation of the memory die MD is switched to the first mode during the execution of the data out operation.

When the memory die MD operates in the third mode to the fifth mode, likewise, when the control terminals /RE and RE are used as any of the control terminals CA2 to CA5, the operation of the memory die MD is switched to another mode during the execution of the data out operation.

### Second Embodiment

For example, as described with reference to FIG. 26, in the description of the semiconductor memory device according to the first embodiment, for example, when the memory die MD operates in the second mode and the control terminals /RE and RE are used as the control terminal CA2(RE) and the control terminal CA3(/RE), the control terminals /RE and RE cannot be used during the data out operation (Dout) of the memory die MD.

In a semiconductor memory device according to a second embodiment, a case where, when the memory die MD operates in the second mode, the control terminal CA2(RE) and the control terminal CA3(/RE) are temporarily disabled during the data out operation (Dout) of the memory die MD, a read enable signal and a complementary signal thereof are input to the control terminals /RE and RE, and the control terminals /RE and RE are used for outputting data through the data signal input/output terminals DQ0 to DQ7 will be described.

### Function of Each of Terminals According to Second Embodiment

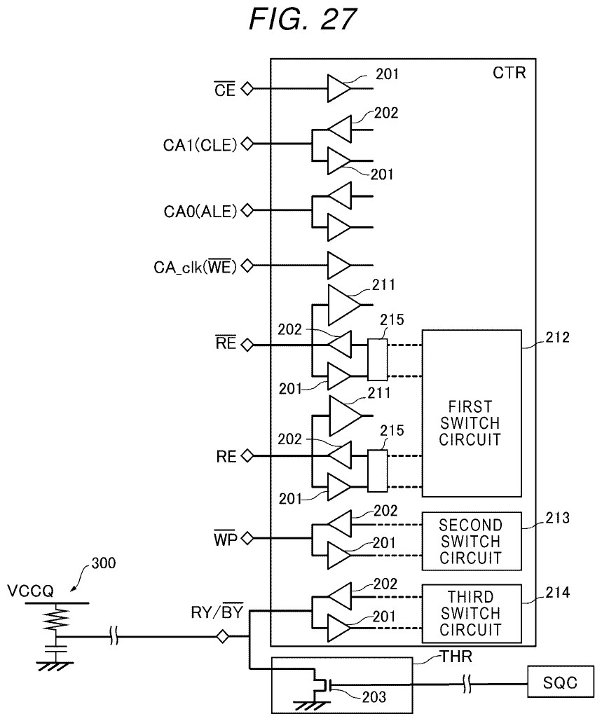

FIG. 27 is a schematic diagram illustrating functions of a signal input/output terminal and a control terminal in the memory die MD according to the second embodiment. FIG. 27 corresponds to FIG. 8, and the same components as those of FIG. 8 are represented by the same reference numerals, and the description thereof will not be repeated.

In the memory die MD according to the second embodiment, for example, as illustrated in FIG. 27, each of the control terminals /RE and RE is also connected to the input circuit 201 and the output circuit 202, and is further connected to the input circuit 211. In addition, the input circuit 201 and the output circuit 202 connected to the control terminals /RE and RE are connected to the first switch circuit 212 through a delay circuit 215.

When a signal from the SCA decoder is a signal representing the start of the data out operation, the delay circuit 215 delays the signal from the SCA decoder and inputs the delayed signal to the control terminal RE. In the example of FIG. 27, when the signal input from the SCA decoder through the first switch circuit is a signal representing the start of the data out operation, the delay circuit 215 delays the signal from the SCA decoder, inputs the delayed signal to the output circuit 202, and inputs the signal to the control terminals /RE and RE.

### Data out Operation of User Data Dat in First Mode

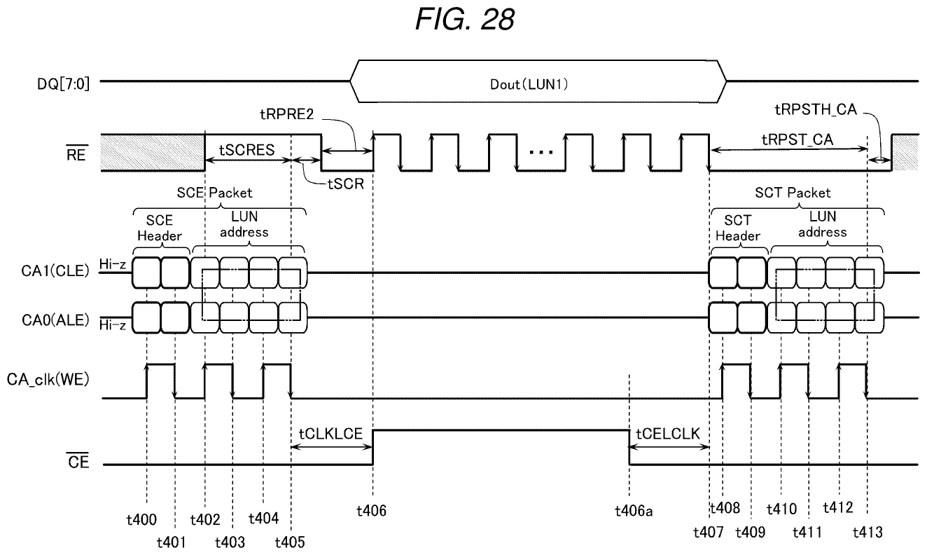

FIG. 28 is a schematic waveform chart illustrating the input/output signals between the controller die CD and the memory die MD. FIG. 28 illustrates a schematic timing chart when the data out operation of the user data Dat is executed during the operation in the first mode.

Before timing t400 of FIG. 28, the voltage of the control terminal /CE falls from “H” to “L”.

In the example of FIG. 28, at timing t400 to timing t401, the controller die CD inputs a SCE header as a header set of 4 bits to the memory die MD through the control terminals CA0(ALE) and CA1(CLE) in units of 2 bits dividedly over 2 cycles. This header set represents the start of the data out operation, and is input at the rising edge and the falling edge of the signal input to the control terminal CA_clk(/WE).

In addition, at timing t402 to timing t405, the controller die CD inputs LUN address data as the body set to the memory die MD through the control terminals CA0(ALE) and CA1(CLE) in units of 2 bits dividedly over 4 cycles. The LUN address data is address data Add designating the memory die MD. When the LUN address data is input, for example, the data out operation of the user data Dat is executed in the designated memory die MD. The SCE header and the LUN address data will also be collectively referred to as a SCE packet.

In addition, at timing t406 after a period tCLKLCE from timing t405 where the SCE packet is input, the voltage of the control terminal /CE rises from “L” to “H”.

In addition, at timing t402 to timing t405 (period tSCRES) and in a period tSCR from timing t405, the voltage of the control terminal /RE is maintained at “H”. After the period tSCR, the voltage of the control terminal /RE is switched from “H” to “L”, and at timing t406 after a period tRPRE2, the controller die CD switches the voltage of the control terminal /RE from “L” to “H”. Next, the switching (toggling) is repeated until timing t407.

As a result, along with the input of the SCE packet, at timing t406 to timing t407, the user data Dat is output through the data signal input/output terminals DQ<7:0>.

In addition, at timing t408 that is a timing after timing t407 and after a predetermined period of time (period tCELCLK) from timing t406a where the voltage of the control terminal /CE falls from “H” to “L”, input of a SCT header starts. That is, at timing t408 to timing t409, the controller die CD inputs the SCT header as a header set of 4 bits to the memory die MD through the control terminals CA0(ALE) and CA1(CLE) in units of 4 bits dividedly over 2 cycles. This header set represents the end of the data out operation, and is input at the rising edge and the falling edge of the signal input to the control terminal CA_clk(/WE).

In addition, at timing t410 to timing t413, the controller die CD inputs the LUN address data as the body set to the memory die MD through the control terminals CA0(ALE) and CA1(CLE). When the LUN address data is input, for example, the data out operation ends in the designated memory die MD. The SCT header and the LUN address data will also be collectively referred to as a SCT packet.

In addition, the voltage of the control terminal /RE falls from “H” to “L” at timing t407, the voltage of the control terminal /RE is maintained at “L” at timing t407 to timing t413 (period tRPST_CA), and further the voltage of the control terminal /RE is switched from “L” to “H” after a period tRPSTH_CA.

In addition, at timing t413, the voltage of the control terminal /CE falls from “H” to “L”.

### Data out Operation of User Data Dat in Second Mode

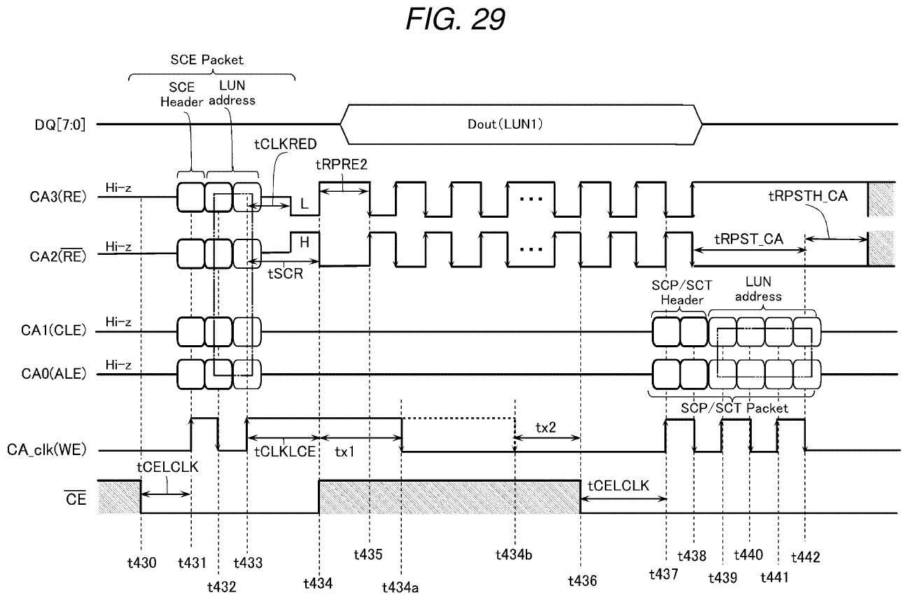

FIG. 29 is a schematic waveform chart illustrating the input/output signals between the controller die CD and the memory die MD. FIG. 29 illustrates a schematic timing chart when the data out operation is executed during the operation in the second mode.

At timing t430 of FIG. 29, the voltage of the control terminal /CE falls from “H” to “L”. The timing t430 is the time a period CELCLK earlier than timing t431.

In the example of FIG. 29, at timing t431, the controller die CD inputs the SCE header as a header set of 4 bits to the memory die MD through the control terminals CA0(ALE), CA1(CLE), CA2(/RE), and CA3(RE) in 1 cycle. This header set is input at the rising edge of the signal input to the control terminal CA_clk(/WE).

In addition, in the example of FIG. 29, at timing t432 to timing t433, the body set of 8 bits corresponding to the falling edge and the rising edge of the signal input to the control terminal CA_clk(/WE) is input. More specifically, at timing t432 to timing t433, the controller die CD inputs LUN address data as the body set to the memory die MD through the control terminals CA0(ALE), CA1(CLE), CA2(/RE), and CA3(RE) in units of 4 bits dividedly over 2 cycles. When the LUN address data is input, for example, the data out operation is executed in the designated memory die MD.

Along with the input of the SCE packet, the voltage of the control terminal CA3(RE) is switched to “L” after a predetermined time tCLKRED, is switched from “L” to “H” at timing t434, and is switched from “H” to “L” at timing t435 after the period tRPRE2. Next, the switching (toggling) is repeated until timing t438. Similarly, along with the input of the SCE packet, the voltage of the control terminal CA2(/RE) is switched to “H” after the predetermined time tCLKRED, is switched from “H” to “L” at timing t434, and is switched from “L” to “H” at timing t435 after the period tRPRE2. Next, the switching (toggling) is repeated until timing t438. The predetermined time tCLKRED is a period of time required until the voltage of the control terminal CA3(RE) is switched to “L” after inputting the SCE packet (timing t433), and is a period of time required until the voltage of the control terminal CA2(/RE) is switched to “H”. In addition, the predetermined time tCLKRED is generated by the delay circuit 215. As a result, the use of the control terminals CA2(/RE) and CA3(RE) as the Data pin is disabled, and the first switch circuit 212 is switched off.

In addition, at timing t434 after the period tCLKLCE from timing t433 where the SCE packet is input, the voltage of the control terminal /CE rises from “L” to “H”. At timing t434a after a predetermined time (t×1) from the switching of the voltage of the control terminal /CE to “H” (from timing t434 in FIG. 29), the control die allows (resets) the signal input to the control terminal CA_clk(/WE) to fall from “H” to “L”. At timing t434b a predetermined time (t×2) earlier than timing t436 where the voltage of the control terminal /CE falls from “H” to “L” instead of timing t434a, the signal input to the control terminal CA_clk(/WE) may fall from “H” to “L”. In other words, until the predetermined time (t×2) is elapsed from timing t434b where the signal input to the control terminal CA_clk(/WE) falls from “H” to “L” (until timing t436), in order to prevent an erroneous operation, the voltage of the control terminal /CE is prohibited from falling from “H” to “L”.

Along with the input of the SCE packet, the voltage of the control terminal CA3(RE) is switched to “L”, the data is output through the data signal input/output terminals DQ<7:0> in a period from timing t434 where the voltage of the control terminal CA2(/RE) is “H” to timing t438. In addition, at timing t436 in a period where the data is output, the voltage of the control terminal /CE falls from “H” to “L”.

In addition, at timing t437 to timing t438 after the period tCLKLCE from timing t436 where the voltage of the control terminal /CE falls from “H” to “L”, the controller die CD inputs the SCT header as a header set of 4 bits to the memory die MD through the control terminals CA0(ALE) and CA1(CLE) in units of 2 bits dividedly over 2 cycles. This header set is input at the rising edge and the falling edge of the signal input to the control terminal CA_clk(/WE). At timing t437 to timing t438, the use of the control terminals CA2(/RE) and CA3(RE) as the Data pin is disabled. Therefore, only the control terminals CA0(ALE) and CA1(CLE) are used as the Data pin.

In addition, in the example of FIG. 29, at timing t439 to timing t442, the body set of 8 bits corresponding to the falling edge and the rising edge of the signal input to the control terminal CA_clk(/WE) is input. More specifically, at timing t439 to timing t442, the controller die CD inputs the LUN address data of 8 bits as the body set to the memory die MD through the control terminals CA0(ALE) and CA1(CLE) in units of 2 bits dividedly over 4 cycles. When the LUN address data is input, for example, the data out operation ends in the designated memory die MD.

In addition, the voltage of the control terminal CA3(RE) rises from “L” to “H” at timing t438, and the voltage of the control terminal CA3(RE) is maintained at “H” at timing t438 to timing t442 (period tRPST_CA) and the following period tRPSTH_CA. Likewise, the voltage of the control terminal CA3(RE) falls from “H” to “L” at timing t438, and the voltage of the control terminal CA3(RE) is maintained at “L” at timing t438 to timing t442 (period tRPST_CA) and the following period tRPSTH_CA.

In this way, when the memory die MD operates in the second mode, during the data out operation of the user data Dat, the use of the control terminals CA2(/RE) and CA3(RE) as the Data pin is disabled.

### Data in Operation of User Data Dat in Second Mode

As described with reference to FIG. 26, during the data out operation of the user data Dat, the control terminals /RE and RE are used. Accordingly, during the execution of the data out operation of the user data Dat, the control terminals /RE and RE cannot be used as the Data pin. On the other hand, during a data in operation of the user data Dat, the control terminals /RE and RE are not used. Accordingly, during the execution of the data in operation of the user data Dat, the control terminals /RE and RE can be used as the Data pin.

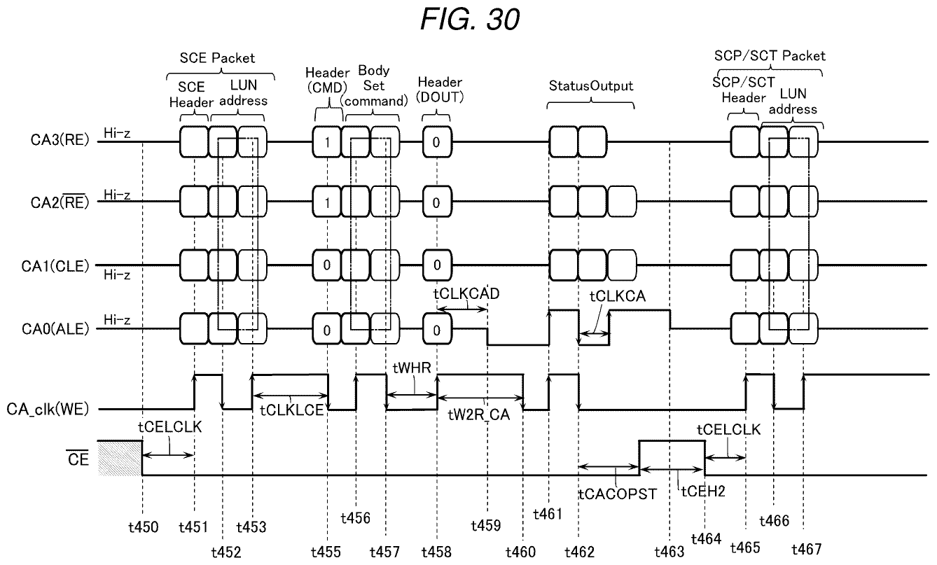

FIG. 30 is a schematic waveform chart illustrating the input/output signals between the controller die CD and the memory die MD. FIG. 30 illustrates a schematic timing chart when the data in operation of the user data Dat is executed during the operation in the second mode.

At timing t450 of FIG. 30, the voltage of the control terminal /CE falls from “H” to “L”. The timing t450 is the time a period CELCLK earlier than timing t451.

In the example of FIG. 30, at timing t451, the controller die CD inputs the SCE header as a header set of 4 bits to the memory die MD through the control terminals CA0(ALE), CA1(CLE), CA2(/RE), and CA3(RE). This header set instructs a LUN address to be input, and represents the start of the data in operation. This header set is input at the rising edge of the signal input to the control terminal CA_clk(/WE). Due to this header set, the use of the control terminals CA2(/RE) and CA3(RE) as the Data pin is enabled.

In addition, at timing t452 to timing t453, the controller die CD inputs LUN address data as the body set to the memory die MD through the control terminals CA0(ALE), CA1(CLE), CA2(/RE), and CA3(RE) in units of 4 bits dividedly over 2 cycles. The LUN address data is address data Add designating the memory die MD. When the LUN address data is input, for example, the data in operation is executed in the designated memory die MD.

In addition, at timing t455 after a predetermined time (after the period tCLKLCE) from timing t453, the controller die CD inputs a header set of 4 bits to the memory die MD through the control terminals CA0(ALE), CA1(CLE), CA2(/RE), and CA3(RE). In the example of FIG. 30, for example, a header set including bits of “0”, “0”, “1”, and “1” is input. As illustrated in FIG. 11, the header set instructs the command data Cmd to be input (CMD) in the body set, and is input at the falling edge of the signal input to the control terminal CA_clk(/WE).

In addition, at timing t456 to timing t457, the controller die CD inputs, for example, the command data 70h as the body set of 8 bits to the memory die MD through the control terminals CA0(ALE), CA1(CLE), CA2(/RE), and CA3(RE) in units of 4 bits dividedly over 2 cycles. The body (data) of 4 bits of the first cycle is input through the control terminals CA0(ALE), CA1(CLE), CA2(/RE), and CA3(RE) at a timing at which the control terminal CA_clk(/WE) rises from “L” to “H”. The body (data) of 4 bits of the second cycle is input through the control terminals CA0(ALE), CA1(CLE), CA2(/RE), and CA3(RE) at a timing at which the control terminal CA_clk(/WE) falls from “H” to “L”.

In addition, at timing t458 after the period tWHR from timing t457, the controller die CD inputs a header set including a header of one cycle representing bits of “0”, “0”, “0”, and “0”, to the memory die MD through the control terminals CA0(ALE), CA1(CLE), CA2(/RE), and CA3(RE). This header set instructs data to be output as illustrated in FIG. 11.

Along with the input of the header set, from timing t460 after a predetermined wait time (after a period tW2R_CA), the controller die CD switches (toggles) the input signal of the control terminal CA_clk(/WE), and designates an output timing of data. As a result, the data output operation starts, and the status data Stt obtained in the status read is output through the control terminals CA1(CLE), CA2(/RE), and CA3(RE) at the falling edge and the rising edge of the output signal of the control terminal CA0(ALE) after timing t461.

In addition, the voltage of the control terminal /CE rises from “L” to “H” after a period tCACOPST from timing t462 where the output of data starts, and falls from “H” to “L” at timing t464 after a period tCEH2.

At timing t465 after a predetermined time (after the period tCELCLK) from timing t464, the controller die CD inputs the SCT header as a header set of 4 bits to the memory die MD through the control terminals CA0(ALE), CA1(CLE), CA2(/RE), and CA3(RE). This header set is input at the rising edge of the signal input to the control terminal CA_clk(/WE).

In addition, at timing t466 to timing t467, the controller die CD inputs LUN address data of 8 bits as the body set to the memory die MD through the control terminals CA0(ALE), CA1(CLE), CA2(/RE), and CA3(RE) in units of 4 bits dividedly over 2 cycles. When the LUN address data is input, for example, the data in operation ends in the designated memory die MD.

### Others

In the description regarding the above-described embodiment, the example of the Data pin used when the memory die MD operates in the second mode to the fifth mode is described. However, in the Data pin used when the memory die MD operates in the second mode to the fifth mode, any combination of the control terminals /RE, RE, and /WP and the terminal RY//BY can be used. In addition, the Data pin used when the memory die MD operates in the second mode to the fifth mode can be set by executing the set feature.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a plurality of semiconductor memory devices; and
a controller circuit,
wherein each of the semiconductor memory devices includes
a first signal pad to which a first signal is input,
a second signal pad to which a second signal is input,
a third signal pad to which a third signal is input,
a fourth signal pad to which a fourth signal is input,
a first input-output circuit configured to receive the second signal as command data or address data in response to toggling of the first signal,
a second input-output circuit configured to output user data through the fourth signal pad in response to toggling of the third signal,
a memory cell array including a plurality of memory cell transistors configured to store the user data,
a first switch circuit configured to connect the third signal pad and the first input-output circuit,
a decoding circuit configured to control the first switch circuit, and
a sequencer including a feature register, and
the decoding circuit is configured to control the first switch circuit in accordance with a first control parameter stored in the feature register and a control signal output from the sequencer when the semiconductor memory device executes a data out operation of outputting the user data through the fourth signal pad.

2. The memory system according to claim 1,
wherein when the first switch circuit is on, the first input-output circuit receives the second signal and the third signal as command data or address data in response to the toggling of the first signal.

3. The memory system according to claim 1,
wherein when the first switch circuit is on, the first input-output circuit is capable of outputting at least one of status data and feature data using the second signal pad and the third signal pad in response to the toggling of the first signal.

4. The memory system according to claim 1,
wherein the control device
inputs a first command to the semiconductor memory device when the data out operation starts, and
inputs a second command to the semiconductor memory device when the data out operation ends, and
when the first control parameter is a first value, the decoding circuit
switches off the first switch circuit in response to an input of the first command, and
switches on the first switch circuit in response to an input of the second command.

5. The memory system according to claim 1, further comprising:
a fifth signal pad to which a fifth signal is input; and
a second switch circuit configured to connect the fifth signal pad and the first input-output circuit,
wherein the decoding circuit
is further connected to the second switch circuit, and
further switches on the second switch circuit in accordance with a second control parameter stored in the feature register.

6. The memory system according to claim 5,
wherein when the second switch circuit is on, the first input-output circuit receives the second signal and the fifth signal as command data or address data in response to the toggling of the first signal.

7. The memory system according to claim 5,
wherein when the second switch circuit is on, the first input-output circuit is capable of outputting at least one of status data and feature data using the second signal pad and the fifth signal pad in response to the toggling of the first signal.

8. The memory system according to claim 5,
wherein when the second switch circuit is off, the fifth signal pad outputs a ready/busy signal representing an operation state of the memory cell array.

9. The memory system according to claim 5,
wherein when the second switch circuit is off, a write-protect signal that restricts data from being written into the memory cell array is received through the fifth signal pad.

10. The memory system according to claim 1, wherein
the first input-output circuit includes
an n-bit register array configured to store a header set of n bits (n represents an integer of 2 or more) and
an 8-bit register array configured to store a body set of 8 bits, and
the first input-output circuit
receives data of m bits (m represents an integer of 3 or more and less than n+8) in response to the toggling of the first signal, and
sequentially stores the received data of m bits in the n-bit register array and the 8-bit register array.

11. A memory system comprising:
a plurality of semiconductor memory devices; and
a controller circuit,
wherein each of the semiconductor memory devices includes
a first signal pad to which a first signal is input,
a second signal pad to which a second signal is input,
a third signal pad to which a third signal is input,
a fourth signal pad to which a fourth signal is input,
a first input-output circuit configured to receive the second signal as command data or address data in response to toggling of the first signal,
a second input-output circuit configured to output user data through the fourth signal pad in response to toggling of the third signal,
a memory cell array including a plurality of memory cell transistors configured to store the user data, and
a first switch circuit configured to connect the third signal pad and the first input-output circuit, wherein
when the first switch circuit is on, the first input-output circuit receives the second signal and the third signal as command data or address data in response to the toggling of the first signal.

12. The memory system according to claim 11, wherein each of the semiconductor memory devices further includes:
a decoding circuit configured to control the first switch circuit, and
a sequencer including a feature register, and
the decoding circuit is configured to control the first switch circuit in accordance with a first control parameter stored in the feature register and a control signal output from the sequencer when the semiconductor memory device executes a data out operation of outputting the user data through the fourth signal pad.

13. The memory system according to claim 12, wherein
the control device inputs a first command to the semiconductor memory device when the data out operation starts, and inputs a second command to the semiconductor memory device when the data out operation ends, and
when the first control parameter is a first value, the decoding circuit switches off the first switch circuit in response to an input of the first command, and switches on the first switch circuit in response to an input of the second command.

14. The memory system according to claim 13, further comprising:
a fifth signal pad to which a fifth signal is input; and
a second switch circuit configured to connect the fifth signal pad and the first input-output circuit,
wherein the decoding circuit
is further connected to the second switch circuit, and
further switches on the second switch circuit in accordance with a second control parameter stored in the feature register.

15. The memory system according to claim 14,
wherein when the second switch circuit is on, the first input-output circuit receives the second signal and the fifth signal as command data or address data in response to the toggling of the first signal.

16. The memory system according to claim 14,
wherein when the second switch circuit is on, the first input-output circuit is capable of outputting at least one of status data and feature data using the second signal pad and the fifth signal pad in response to the toggling of the first signal.

17. The memory system according to claim 14,
wherein when the second switch circuit is off, the fifth signal pad outputs a ready/busy signal representing an operation state of the memory cell array.

18. The memory system according to claim 14,
wherein when the second switch circuit is off, a write-protect signal that restricts data from being written into the memory cell array is received through the fifth signal pad.

19. The memory system according to claim 11, wherein
the first input-output circuit includes
an n-bit register array configured to store a header set of n bits (n represents an integer of 2 or more) and
an 8-bit register array configured to store a body set of 8 bits, and
the first input-output circuit
receives data of m bits (m represents an integer of 3 or more and less than n+8) in response to the toggling of the first signal, and
sequentially stores the received data of m bits in the n-bit register array and the 8-bit register array.

20. A method of transferring data between a plurality of semiconductor memory devices and a controller circuit, wherein each of the semiconductor memory devices includes
a first signal pad to which a first signal is input,
a second signal pad to which a second signal is input,
a third signal pad to which a third signal is input,
a fourth signal pad to which a fourth signal is input,
a first input-output circuit configured to receive the second signal as command data or address data in response to toggling of the first signal,
a second input-output circuit configured to output user data through the fourth signal pad in response to toggling of the third signal,
a memory cell array including a plurality of memory cell transistors configured to store the user data,
a first switch circuit configured to connect the third signal pad and the first input-output circuit,
a decoding circuit configured to control the first switch circuit, and
a sequencer including a feature register,
said method comprising:
controlling the first switch circuit in accordance with a control parameter stored in the feature register and a control signal output from the sequencer when the semiconductor memory device executes a data out operation of outputting the user data through the fourth signal pad, wherein
when the first switch circuit is on, the first input-output circuit receives the second signal and the third signal as command data or address data in response to the toggling of the first signal.
